(19) United States
(12) Patent Application Publication
(10) Pub. No.: US 2025/0337161 A1
(43) Pub. Date: Oct. 30, 2025

(54) ANTENNA MODULE

(71) Applicant: Murata Manufacturing Co., Ltd., Nagaokakyo-shi (JP)

(72) Inventors: Hideki UEDA, Nagaokakyo-shi (JP); Ryotaro OHASHI, Nagaokakyo-shi (JP); Shinya MIZOGUCHI, Nagaokakyo-shi (JP); Hideyuki MORIMOTO, Nagaokakyo-shi (JP); Kengo ONAKA, Nagaokakyo-shi (JP)

(73) Assignee: Murata Manufacturing Co., Ltd., Nagaokakyo-shi (JP)

(21) Appl. No.: 19/264,871

(22) Filed: Jul. 10, 2025

Related U.S. Application Data
(63) Continuation of application No. PCT/JP2023/045304, filed on Dec. 18, 2023.

(30) Foreign Application Priority Data
Jan. 27, 2023 (JP) 2023-011091

(51) Int. Cl. H01Q 1/52; H01Q 9/04; H01Q 21/00; H01Q 21/06; H01Q 21/24

(52) U.S. Cl. CPC H01Q 1/523; H01Q 9/045; H01Q 21/0006; H01Q 21/06; H01Q 21/24

(57) ABSTRACT

An antenna module includes a first plate section and a second plate section that intersect at an angle other than 180°, and at least one circuit. Each circuit includes first radiating elements on the first plate section and second radiating elements on the second plate section. A radio frequency integrated circuit (RFIC) is on a surface of the first plate section and includes a plurality of input-output terminals for high-frequency signals. Hybrid circuits are on the first plate section, each with two input ports and two output ports. Input traces for each hybrid circuit connect the hybrid circuit input ports to the RFIC, while first and second traces connect the hybrid circuit output ports to the first and second radiating elements, respectively. The hybrid circuits at least partially overlap the RFIC. A number of hybrid circuits on either side of a center plane is equal to or differs by one.

### CROSS-REFERENCE TO RELATED APPLICATIONS

The present application is a continuation of PCT/JP2023/045304, filed Dec. 18, 2023, which claims priority to Japanese patent application JP 2023-011091, filed Jan. 27, 2023, the entire contents of each of which being incorporated herein by reference.

### TECHNICAL FIELD

The present disclosure relates to an antenna module.

### BACKGROUND ART

An antenna module is publicly known in which a radio frequency integrated circuit feeds power to radiating elements via a hybrid circuit (Patent Document 1). This antenna module includes two dielectric boards arranged so as to have different normal directions. In each of the two dielectric boards, plural radiating elements are arranged. The two dielectric boards are connected to each other through a connecting section. The radio frequency integrated circuit is mounted on one of the dielectric boards.

Two input ports of the hybrid circuit are individually connected to two signal input-output terminals of the radio frequency integrated circuit. One output port, among two output ports of the hybrid circuit, is connected to one of the radiating elements in one of the dielectric boards while the other output port is connected to one of the radiating elements in the other dielectric board. Feed lines to the radiating elements arranged in the dielectric board, among the two dielectric boards, in which the hybrid circuit is not arranged are routed via the connecting section.

When the hybrid circuit is operated as a power combining circuit, the high-frequency signals output from the respective signal input-output terminals of the radio frequency integrated circuit may be combined and feed a resulting high-frequency signal having a power approximately twice the power of the high-frequency signals output from the signal input-output terminals, to the radiating elements of the dielectric board selected from the two dielectric boards.

### CITATION LIST

### Patent Document

Patent Document 1: International Publication No. 2022/224650

### SUMMARY

### Technical Problems

The fifth-generation mobile communication system (5G) uses multiple frequency bands in a frequency range from 37 GHz to 48.2 GHz, for example. The radio frequency integrated circuit and radiating elements may be designed to cover these multiple frequency bands. If the hybrid circuit and the like are designed to optimize the operation at a specific frequency among frequencies to be covered, the hybrid circuit fails to adequately combine high-frequency signals at frequencies deviating from the specific frequency in some cases. For example, the power of the high-frequency signal resulting from inadequate combining is partially fed to the radiating elements of the dielectric board (a plate section) not selected, resulting in reduction of the power of the high-frequency signal fed to the radiating elements of the selected dielectric board (the plate section).

In the case of reception of radio waves, high-frequency signals received by the radiating elements in the plate section not selected are superimposed as noise. That is, isolation between the radiating elements of the two plate sections is reduced. Embodiments are directed to providing an antenna module having a configuration suitable for preventing reduction of isolation between the radiating elements of the two plate sections.

### Solutions to Problems

According to one aspect, one or more embodiments are directed to an antenna module, including a first plate section and a second plate section that extend along two planes intersecting at an angle other than 180°, a connecting section that connects the first plate section and the second plate section, and at least one circuit. Each of the at least one circuit unit includes a plurality of first radiating elements on the first plate section and a plurality of second radiating elements on the second plate section. Each radiating element has at least one feed point and radiates radio waves. A radio frequency integrated circuit (RFIC) is on a surface of the first plate section facing the side opposite to the side of the plurality of first radiating elements. The RFIC includes a plurality of input-output terminals through which high-frequency signals are input and output.

A plurality of hybrid circuits are on the first plate section for the respective feed points of the plurality of first radiating elements, each hybrid circuit including two input ports and two output ports. Two input traces that are provided for each of the plurality of hybrid circuits and connect the respective two input ports to two of the plurality of input-output terminals of the RFIC. A first trace that connects a first output port of each of the plurality of hybrid circuits to a corresponding one of the plurality of first radiating elements and a second trace that connects the a second output port of each of the plurality of hybrid circuits to a corresponding one of the plurality of second radiating elements.

Each of the at least one circuit includes, in plan view of the first plate section, with respect to a second direction perpendicular to a first direction, which is parallel to a line of intersection of the two planes, the plurality of hybrid circuits are individually arranged to at least partially overlap the RFIC. A number of hybrid circuits arranged on one side of a center plane is equal to or differs by one from a number of hybrid circuits arranged on the other side, the center plane passing through the geometric center of the RFIC and being perpendicular to the first direction.

### Advantageous Effects

According to the present disclosure, the design of the wiring layout suitable for preventing reduction of isolation between the first radiating elements of the first plate section and the second radiating elements of the second plate section may be facilitated.

### BRIEF DESCRIPTION OF DRAWINGS

FIG. 1A is a perspective view of an antenna module according to a first embodiment, and FIG. 1B is a schematic perspective view for explaining the positional relationship between a first plate section and a second plate section.

FIG. 2 is a schematic diagram illustrating an electrical connection relationship in a circuit unit of the antenna module according to the first embodiment.

FIG. 3 is a block diagram of the antenna module according to the first embodiment.

FIG. 4 is a schematic diagram illustrating the positional relationship between constituent elements in plan view of the first plate section, second plate section, and connecting sections.

FIG. 5 is an equivalent circuit diagram for analyzing the influence of the difference in line length between two input traces on the output characteristics of a hybrid circuit.

FIG. 6 is a graph illustrating the frequency dependence of the power of an output signal from an output port P3.

FIG. 7 is a graph illustrating the frequency dependence of the power of an output signal from an output port P4.

FIG. 8 is a schematic diagram illustrating the positional relationship between constituent elements in plan view of a first plate section, a second plate section, and connecting sections of an antenna module according to a second embodiment.

FIG. 9 is a graph illustrating the relationship between bit error rate (BER) and carrier-to-noise ratio (CNR) when the modulation scheme is QPSK.

FIG. 10 is a graph illustrating the calculation result of the CNR of the carrier output from the output port P3 to noise output from the output port P4.

FIG. 11 is a schematic diagram illustrating the positional relationship between constituent elements in plan view of a first plate section, a second plate section, and connecting sections of an antenna module according to a third embodiment.

FIG. 12 is a graph illustrating the relationship between the number of radiating elements constituting a linear array antenna and 3 dB beamwidth.

FIG. 13 is a schematic diagram illustrating the relationship between two radiating elements and the beam direction.

FIG. 14 is a graph illustrating the array factor of a four-element array antenna.

FIG. 15 is a graph illustrating the relationship between the difference in line length between feed lines and the amount of deviation in the phase difference, as well as the relationship between the difference in line length between feed lines and the angle of deviation in the beam direction.

FIG. 16 is a schematic diagram illustrating a schematic sectional structure of an antenna module according to a fourth embodiment.

FIG. 17 is a schematic diagram illustrating the positional relationship between constituent elements in plan view of a first plate section, a second plate section, and connecting sections of an antenna module according to a fifth embodiment.

FIG. 18 is a schematic diagram illustrating the positional relationship between constituent elements in plan view of a first plate section, a second plate section, and connecting sections of an antenna module according to a sixth embodiment.

FIG. 19 is a schematic diagram illustrating the positional relationship between constituent elements in plan view of a first plate section, a second plate section, and connecting sections of an antenna module according to a seventh embodiment.

FIGS. 20A and 20B are, respectively, a sectional view and a perspective view of two first radiating elements overlapping each other.

FIG. 21 is a perspective view of an antenna module according to an eighth embodiment.

FIG. 22 is a schematic plan view of a hybrid circuit used in an antenna module according to a ninth embodiment.

FIG. 23 is a schematic plan view of a hybrid circuit used in an antenna module according to a tenth embodiment.

FIG. 24 is an equivalent circuit diagram of a hybrid circuit used in an antenna module according to an 11th embodiment and transmission lines connected to the hybrid circuit.

FIG. 25 is an equivalent circuit diagram of a hybrid circuit used in an antenna module according to a modification of the 11th embodiment and transmission lines connected to the hybrid circuit.

### DESCRIPTION OF EMBODIMENTS

### First Embodiment

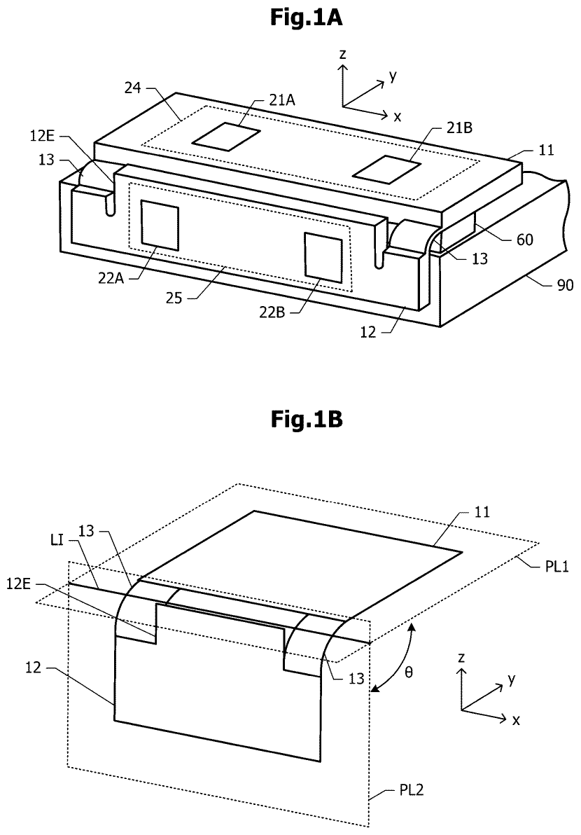

With reference to FIGS. 1A to 9, an antenna module according to a first embodiment will be described.

FIG. 1A is a perspective view of the antenna module according to the first embodiment. The antenna module according to the first embodiment includes a flat plate-shaped first plate section 11, a flat plate-shaped second plate section 12, and connecting sections 13, which connect the both.

FIG. 1B is a schematic perspective view for explaining the positional relationship between the first plate section 11 and the second plate section 12. The first and second plate sections 11 and 12 are respectively extended along two planes PL1 and PL2, which intersect at an angle θ other than 180° along a straight line as a line LI of intersection. The first and second plate sections 11 and 12 include portions arranged in a common range with respect to the direction parallel to the line LI of intersection. In other words, a longest portion of each of the first and second plate sections 11 and 12 may be co-extensive along a direction of the line LI, here the x-direction. Herein, “a plate section is extended along a plane” indicates the positional relationship in which at least one of the surfaces of the plate section is parallel to the plane and the plane is located between the two surfaces of the plate section or includes one of the two surfaces.

In the first embodiment, the angle θ is 90°. The angle θ needs to be greater than 0° and smaller than 180°.

Defined is an xyz orthogonal coordinate system where the x-axis is the axis parallel to the line LI of intersection and the z-axis is perpendicular to the plane PL1, along which the first plate section 11 extends. When the angle θ is 90°, the normal direction of the plane PL2 is parallel to the y-axis.

The connecting sections 13 extend from an edge of the first plate section 11 that is parallel to the x-axis, in the negative direction of the y-axis and gradually bend in the negative direction of the z-axis to reach the second plate section 12. The second plate section 12 includes a portion extending from the connecting sections 13 in the negative direction of the z-axis. The tangent plane of each connecting section 13 at the position where the connecting section 13 connects to the first plate section 11 is parallel to the plane PL1 while the tangent plane at the position where the connecting section 13 connects to the second plate section 12 is parallel to the plane PL2. The connecting sections 13 are arranged at two locations apart in the x-direction. The second plate section 12 includes an extension portion 12E where the connecting sections 13 are not arranged with respect to the x-direction. The extension portion 12E extends in the positive direction of the z-axis from the position in the z-direction where the second plate section 12 connects to the connecting sections 13. The extension portion 12E may extend beyond the line LI of intersection. The connecting sections 13 (FIG. 1A) are thinner than the first and second flat plate sections 11 and 12.

As illustrated in FIG. 1A, two first radiating elements 21A and 21B are arranged in the first plate section 11, and two second radiating elements 22A and 22B are arranged in the second plate section 12. The first radiating elements 21A and 21B constitute a patch antenna together with a ground conductor 24, which is arranged inside the first plate section 11, and radiate radio waves into one of two spaces partitioned by the plane PL1 (FIG. 1A), for example, space on the positive side of the z-axis. The second radiating elements 22A and 22B constitute a patch antenna together with a ground conductor 25, which is arranged inside the second plate section 12, and radiate radio waves into one of two spaces partitioned by the plane PL2 (FIG. 1A), for example, space on the negative side of the y-axis. The first radiating elements 21A and 21B and the second radiating elements 22A and 22B radiate radio waves in mutually different directions.

On the surface of the first plate section 11 facing the negative side of the z-axis, a radio frequency integrated circuit (RFIC) 60 is mounted. The radio frequency integrated circuit 60 includes plural input-output terminals through which high frequency signals are input and output.

The antenna module according to the first embodiment is mounted on a module substrate 90 such that the surface of the first plate section 11 on which the radio frequency integrated circuit 60 is mounted faces one of the surfaces of the module substrate 90 and the surface of the second plate section 12 facing the positive side of the y-axis faces an end face of the module substrate 90.

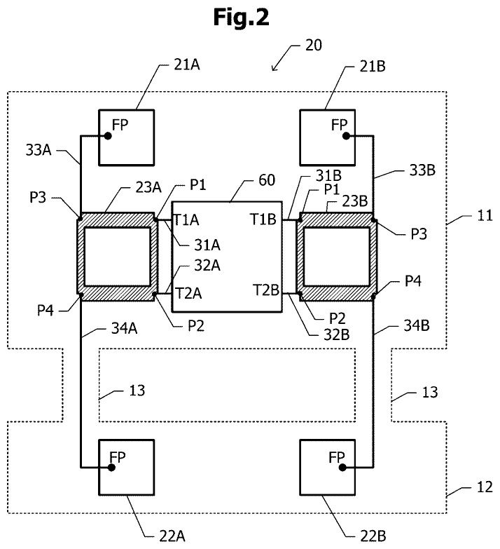

FIG. 2 is a schematic diagram illustrating an electric connection relationship in a circuit unit of the antenna module according to the first embodiment. The two first radiating elements 21A and 21B and two hybrid circuits 23A and 23B are arranged in the first plate section 11. That is, the plural hybrid circuits 23A and 23B are respectively arranged for the plural first radiating elements 21A and 21B. This can also mean that each of the plural first radiating elements 21A and 21B includes a single feed point (FP) and the plural hybrid circuits 23A and 23B are arranged for the respective feed points of the plural first radiating elements 21A and 21B. The radio frequency integrated circuit 60 is mounted in the first plate section 11.

Each of the hybrid circuits 23A and 23B is a so-called 90° hybrid circuit (a branch-line hybrid circuit). The two hybrid circuits 23A and 23B have the same configuration, and the configuration of the hybrid circuit 23A will be described below.

The hybrid circuit 23A includes two input ports P1 and P2 and two output ports P3 and P4. The input ports P1 and P2, as well as the output ports P3 and P4, are connected through a transmission line having a characteristic impedance Z₀. The input port P1 and the output port P3, as well as the input port P2 and the output port P4, are connected through a transmission line having a characteristic impedance of Z₀/2^{1/2}. The line length of these four transmission lines is one-fourth of the wavelength of a high-frequency signal having a specific frequency within the operating frequency band.

When high-frequency signals having a mutual phase difference of 90° are input to the input ports P1 and P2, the two high-frequency signals are combined to be output from one of the output ports P3 and P4 while no high-frequency signal appears at the other output port. When the phase of the high-frequency signal input to the input port P2 is 90° ahead of the phase of the high-frequency signal input to the input port P1, the high-frequency signal resulting from their combination is output from the output port P3. When the phase of the high-frequency signal input to the input port P2 is 90° behind the phase of the high-frequency signal input to the input port P1, the high-frequency signal resulting from their combination is output from the output port P4.

When high-frequency signals are input to the output ports P3 and P4, the high-frequency signal resulting from their combination is output from one of the input ports P1 and P2.

The two input ports P1 and P2 of the hybrid circuit 23A are connected to two input-output terminals T1A and T2A of the radio frequency integrated circuit 60 through input traces 31A and 32A, respectively. The two output ports P3 and P4 of the hybrid circuit 23A are connected to the feed points FP of the first and second radiating elements 21A and 22A through a first trace 33A and a second trace 34A, respectively.

The two input ports P1 and P2 of the other hybrid circuit 23B are connected to two input-output terminals T1B and T2B of the radio frequency integrated circuit 60 through input traces 31B and 32B, respectively. The two output ports P3 and P4 of the hybrid circuit 23B are connected to the feed points FP of the first and second radiating elements 21B and 22B through a first trace 33B and a second trace 34B, respectively.

The input traces 31A, 32A, 31B, and 32B and the first traces 33A and 33B are arranged inside the first plate section 11. The second trace 34A extends from the first plate section 11 to the second plate section 12 via one of the connecting sections 13. The other second trace 34B extends from the first plate section 11 to the second plate section 12 via the other connecting section 13.

The plural first radiating elements 21A and 21B and the plural second radiating elements 22A and 22B have the same resonant frequency. The plural hybrid circuits 23A and 23B have the same shape and dimensions. The circuit from the radio frequency integrated circuit 60 illustrated in FIG. 2 to the plural first radiating elements 21A and 21B and the plural second radiating elements 22A and 22B, which operate in the same frequency band, is referred to as a single circuit unit 20.

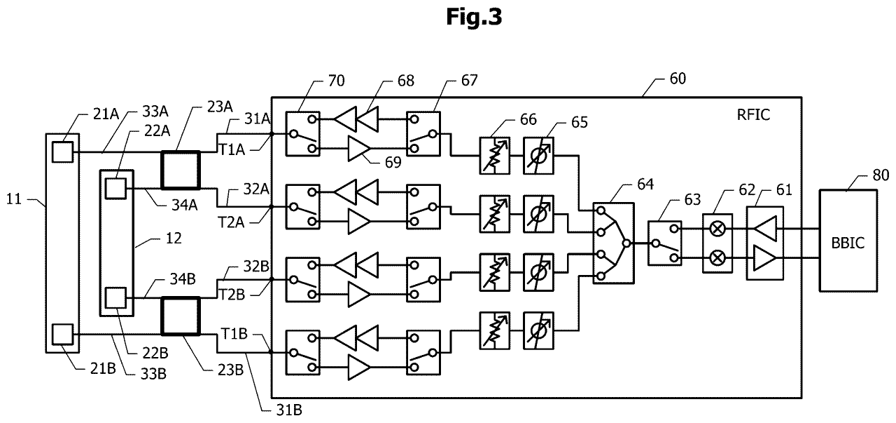

FIG. 3 is a block diagram of an antenna module according to the first embodiment.

The radio frequency integrated circuit 60 includes an intermediate frequency amplifier 61, an up/down conversion mixer 62, a transmission-reception switch 63, a power divider 64, plural phase shifters 65, plural attenuators 66, plural transmission-reception switches 67, plural power amplifiers 68, plural low-noise amplifiers 69, and plural transmission-reception switches 70. The nodes of the plural transmission-reception switches 70 are individually connected to the input-output terminals T1A, T1B, T2A, and T2B.

The configuration from the input-output terminals T1A, T1B, T2A, and T2B to the first radiating elements 21A and 21B and second radiating elements 22A and 22B are as described with reference to FIG. 2.

Next, the transmission function will be described. An intermediate-frequency signal is input from a baseband integrated circuit (BBIC) 80 to the up/down conversion mixer 62 via the intermediate frequency amplifier 61. The baseband integrated circuit 80 is mounted in, for example, the module substrate 90 (FIG. 1A). The up/down conversion mixer 62 up-converts the intermediate-frequency signal to generate a high-frequency signal. The generated high-frequency signal is input to the power divider 64 via the transmission-reception switch 63. High-frequency signals distributed by the power divider 64 are individually output from the input-output terminals T1A, T2A, T1B, and T2B via the phase shifters 65, attenuators 66, transmission-reception switches 67, power amplifiers 68, and transmission-reception switches 70.

By controlling the phase shifters 65 to adjust the phase difference between two high-frequency signals input to each of the hybrid circuits 23A and 23B, high-frequency signals can be fed to one of the first and second radiating elements 21A and 22A and one of the first and second radiating elements 21B and 22B.

Next, the reception function will be described. High-frequency signals received by the first and second radiating elements 21A and 22A are input to the input-output terminals T1A and T2A via the hybrid circuit 23A. High-frequency signals received by the first and second radiating elements 21B and 22B are input to the input-output terminals T1B and T2B via the hybrid circuit 23B. The high-frequency signals input to the input-output terminals T1A, T2A, T1B, and T2B are input to the power divider 64 via the transmission-reception switches 70, low-noise amplifiers 69, transmission-reception switches 67, attenuators 66, and phase shifters 65.

The high-frequency signal resulting from the combining by the power divider 64 is input to the up/down conversion mixer 62 via the transmission-reception switch 63. The up/down conversion mixer 62 down-converts the high-frequency signal to generate an intermediate-frequency signal. The generated intermediate-frequency signal is input to the baseband integrated circuit 80 via the intermediate frequency amplifier 61. The reception function may adopt a direct conversion method in which the up/down conversion mixer 62 directly down-converts the high-frequency signal to a baseband signal.

By controlling the phase shifters 65, only the high-frequency signals received by either the combination of the first radiating elements 21A and 21B or the combination of the second radiating elements 22A and 22B can be input to the up/down conversion mixer 62 to be demodulated.

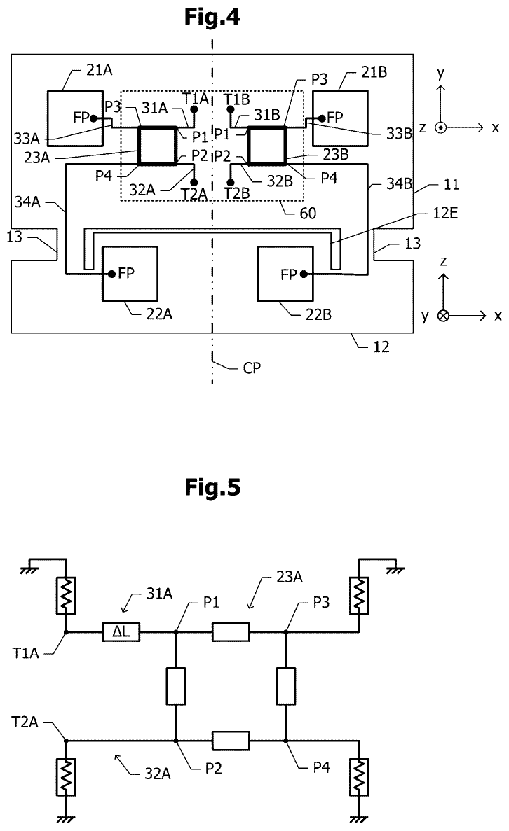

FIG. 4 is a schematic diagram illustrating the positional relationship between constituent elements when the first plate section 11, second plate section 12, and connecting sections 13 are individually viewed in plan view. The first plate section 11 is illustrated such that its direction perpendicular to the plane of the paper is parallel to the z-direction while the second plate section 12 is illustrated such that its direction perpendicular to the plane of the paper is parallel to the y-direction.

With respect to the y direction, the range in which each of the two hybrid circuits 23A and 23B is arranged and the range in which the radio frequency integrated circuit 60 is arranged at least partially overlap. For example, with respect to the y direction, each of the two hybrid circuits 23A and 23B is arranged in the range in which the radio frequency integrated circuit 60 is arranged.

The input-output terminals T1A and T2A of the radio frequency integrated circuit 60 are connected to the two input ports P1 and P2 of the hybrid circuit 23A through the two input traces 31A and 32A, respectively. The two output ports P3 and P4 of the hybrid circuit 23A are connected to the feed points FP of the first and second radiating elements 21A and 22A through the first and second traces 33A and 34A, respectively.

The input-output terminals T1B and T2B of the radio frequency integrated circuit 60 are connected to the two input ports P1 and P2 of the hybrid circuit 23B through the two input traces 31B and 32B, respectively. The two output ports P3 and P4 of the hybrid circuit 23B are connected to the feed points FP of the first and second radiating elements 21B and 22B through the first and second traces 33B and 34B, respectively.

The virtual plane that passes through the geographic center of the radio frequency integrated circuit 60 and is perpendicular to the x-direction is referred to as a center plane CP. The hybrid circuit 23A is arranged on one side of the center plane CP in the x-direction while the other hybrid circuit 23B is arranged on the other side. That is, the number of hybrid circuits arranged on one side of the center plane CP is equal to the number of hybrid circuits arranged on the other side.

The connecting sections 13 are arranged at two locations on the respective sides of the center plane CP, spaced apart in the x-direction. The two second traces 34A and 34B are routed via the connecting sections 13 on the same side of the center plane CP as the respective hybrid circuits 23A and 23B, to which the second traces 34A and 34B are respectively connected. The order of the second radiating elements 22A and 22B in the x-direction is the same as the order of the hybrid circuits 23A and 23B in the x-direction, which are connected to the second radiating elements 22A and 22B, respectively. The two second radiating elements 22A and 22B are arranged within the range of the extension portion 12E of the second plate section 12 in the x-direction.

In each of the two hybrid circuits 23A and 23B, the two output ports P3 and P4 are arranged farther from the center plane CP than the two input ports P1 and P2. For example, the two output ports P3 and P4 are arranged at the same position in the x-direction, and the two input ports P1 and P2 are also located at the same position in the x direction.

Among the plural input-output terminals of the radio frequency integrated circuit 60, the two input-output terminals T1A and T2A, which are connected to the hybrid circuit 23A, are arranged at the same position in the x-direction and are spaced apart in the y-direction. In a similar manner, the two input-output terminals T1B and T2B, which are connected to the hybrid circuit 23B, are arranged at the same position in the x-direction and are spaced apart in the y-direction.

The radio waves radiated from the two first radiating elements 21A and 21B are linearly polarized. The polarization directions of the first radiating elements 21A and 21B are parallel to each other. The radio waves radiated from the two second radiating elements 22A and 22B are also linearly polarized. The polarization directions of the second radiating elements 22A and 22B are parallel to each other.

Next, an example method of manufacturing an antenna module according to the first embodiment will be described.

A flat plate-shaped substrate is prepared, in which a multilayer wiring structure including the first radiating elements 21A and 21B, second radiating elements 22A and 22B, ground conductors 24 and 25 (FIG. 1A), traces, and the like is formed. The flat plate-shaped substrate can be produced by using a publicly-known method for manufacturing a printed wiring substrate, a low temperature co-fired ceramics (LTCC) substrate, a liquid crystal polymer (LCP) substrate, or the like.

This flat plate-shaped substrate is partially processed to form the relatively thin connecting sections 13 (FIG. 1A). A slit to separate the first plate section 11 and the second plate section 12 from each other is formed. Then, the connecting sections 13 are bent or curved. This manufacturing method is described in the specification of International Publication No. 2020/170722.

Alternatively, the first plate section 11 and the second plate section 12 may be produced separately and bonded to a relatively thin substrate, and then the thin substrate may be curved.

Next, the excellent effects of the first embodiment will be described with reference to FIGS. 5, 6, and 7.

Simulations were performed for the relationship between the difference in line length between the two input traces 31A and 32A, which are connected to the hybrid circuit 23A, and the characteristics of the hybrid circuit 23A as a power combiner. Hereinafter, the simulation results will be described. The characteristics of the other hybrid circuit 23B are the same as those of the hybrid circuit 23A.

FIG. 5 is an equivalent circuit diagram for analyzing the influence of the difference in line length between the two input traces 31A and 32A on the output characteristics of the hybrid circuit 23A. The input ports P1 and P2 of the hybrid circuit 23A are connected to the input-output terminals T1A and T2A through the input traces 31A and 32A, respectively. The line length of the input trace 31A is ΔL longer than the line length of the other input trace 32A. In the following analysis, an example will be described which operates in a frequency band ranging from 37 GHz to 48.2 GHz, which is used in 5G. The center frequency of this frequency band is 42.6 GHz.

High-frequency signals having the same power are input from the input-output terminals T1A and T2A to the hybrid circuit 23A. Herein, a phase difference is applied to the high-frequency signals to be input to the two input-output terminals T1A and T2A such that at the center frequency of 42.6 GHz, the phase at the input port P2 is 90° ahead of the phase at the input port P1. In this process, a signal is output from the output port P3 while no signal is output from the other output port P4.

Since the input traces 31A and 32A have different line lengths, if frequencies of input high-frequency signals deviate from the center frequency, the phase difference between the high-frequency signals at the input ports P1 and P2 deviate from 90°. When the phase difference deviates from 90°, a high-frequency signal will also be output from the output port P4. That is, the isolation between the two output ports P3 and P4 is reduced.

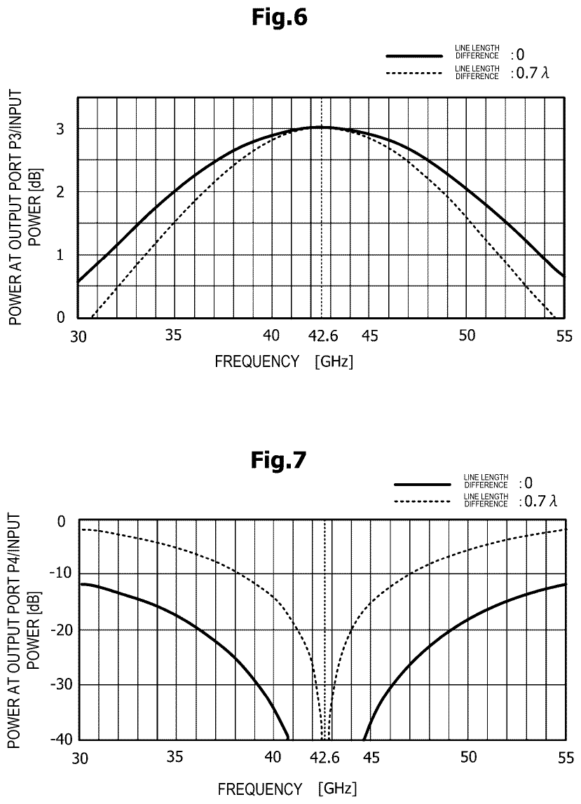

FIGS. 6 and 7 are graphs illustrating frequency dependences of the powers of output signals from the output ports P3 and P4, respectively. The horizontal axes represent frequency in units of GHz, and the vertical axes of the graphs in FIGS. 6 and 7 respectively represent the ratios of the powers (hereinafter, referred to as powers at output ports) of output signals from the output ports P3 and P4 to the powers of the input signals in units of dB. The solid lines in the graphs represent calculation results when the two input traces 31A and 32A have the same line length. The dashed lines represent calculation results when the difference in line length between the two input traces 31A and 32A is 0.7 times the wavelength of a high-frequency signal at the center frequency of 42.6 GHz.

The line length of the transmission line connecting the two input ports P1 and P2 is one-fourth of the wavelength of a signal at the center frequency. The characteristic impedance of the transmission line connecting the two input ports P1 and P2 is equal to the characteristic impedance of the two input traces 31A and 32A. Therefore, the difference in line length that is 0.7 times the wavelength corresponds to 2.8 times the line length of the transmission line connecting the two input ports P1 and P2.

At the center frequency of 42.6 GHz, where the phase adjustment is optimized, the power at the output port P3 is twice the power of the input signal as illustrated in FIG. 6 while no signal is output from the output port P4 as illustrated in FIG. 7. When the line lengths of the two input traces 31A and 32A are equal, the power at the output port P3 decreases as the input signal frequency deviates from the center frequency of 42.6 GHz while the power at the output port P4 increases. This is due to the frequency dependence of the hybrid circuit 23A itself.

When the line lengths of the two input traces 31A and 32A are different, as the input signal frequency deviates from the center frequency of 42.6 GHz, the decrease in power at the output port P3 is increased, compared to the case where the line lengths are equal, while the increase in power at the output port P4 is increased, compared to the case where the line lengths are equal. This is because the phase difference between input signals at the input ports P1 and P2 deviates from 90° due to the difference in line length between the input traces 31A and 32A. Part of the power intended to be output from the output port P3 is output from the output port P4, resulting in reduction of isolation between the first radiating element 21A and the second radiating element 22A (FIG. 4), which are connected to the two output ports P3 and P4, respectively.

Furthermore, when one of the first and second radiating elements 21A and 22A receives a signal, another signal received by the other radiating element is superimposed as noise.

These simulation results reveal in order to prevent reduction of isolation between the first and second radiating elements 21A and 22A, the difference in line length between the two input traces 31A and 32A should be minimized.

In the first embodiment, in plan view of the first plate section 11, the ranges in which the two hybrid circuits 23A and 23B are individually arranged and the range in which the radio frequency integrated circuit 60 is arranged at least partially overlap in the y-direction as illustrated in FIG. 4. In the embodiment shown in FIG. 4, the radio frequency integrated circuit 60 overlaps both of the two hybrid circuits 23A and 23B in their entirety. Furthermore, the hybrid circuit 23A is arranged on one side of the center plane CP (FIG. 4) while the other hybrid circuit 23B is arranged on the other side. This facilitates the design of a wiring layout that minimizes the difference in line length between the two input traces 31A and 32A, which connect the radio frequency integrated circuit 60 to the hybrid circuit 23A. Similarly, the design of a wiring layout that minimizes the difference in line length between the two input traces 31B and 32B, which connect the radio frequency integrated circuit 60 to the hybrid circuit 23B, also becomes easier.

To improve the ease of designing the wiring layout, with respect to the y-direction, each of the hybrid circuits 23A and 23B may be arranged within the range in which the radio frequency integrated circuit 60 is arranged, i.e., fully overlap the radio frequency integrated circuit 60 in the y-direction.

Furthermore, the two input ports P1 and P2 of the hybrid circuit 23A are arranged at the same position in the x-direction while the input-output terminals T1A and T2A of the radio frequency integrated circuit 60, which are respectively connected to the input ports P1 and P2, are also arranged at the same position in the x-direction. Such a configuration further facilitates the design of a wiring layout that minimizes the difference in line length between the input traces 31B and 32B. The same applies to the positional relationship between the two input ports P1 and P2 of the other hybrid circuit 23B and the relationship between the input-output terminals T1B and T2B, which are connected to the input ports P1 and P2, respectively.

In the first embodiment, the two connecting sections 13 are arranged at two locations on the respective sides of the center plane CP, spaced apart in the x-direction. The second trace 34A is routed via one of the connecting sections 13 while the other second trace 34B is routed via the other connecting section 13. Adopting a configuration in which the two second traces 34A and 34B are routed via one of the connecting sections 13 requires an increase in width (the dimension in the x-direction) of the connecting section 13 which the second traces 34A and 34B pass through. In order to maintain sufficient mechanical strength, the connecting section 13 which the second traces 34A and 34B do not pass through cannot be made extremely narrow. Therefore, the total width of the connecting sections 13 will be larger than that in the configuration of the first embodiment.

If the total width of the connecting sections 13 increases, the dimension of the extension portion 12E of the second plate section 12 in the x-direction decreases. This reduces the range in which the second radiating elements 22A and 22B can be arranged. In the first embodiment, the dimension of the extension portion 12E in the x-direction can be increased. As the dimension of the extension portion 12E increases, the area of the ground conductor 25 (FIG. 1A) can be increased. Increasing the area of the ground conductor 25 can improve the gain of the second radiating elements 22A and 22B.

In the first embodiment, each of the two second places 34A and 34B passes through the connecting section 13 on the same side of the center plane CP as the side where the corresponding hybrid circuit 23A or 23B is arranged. This facilitates the design of a wiring layout that minimizes the difference in line length between the two second traces 34A and 34B, compared to the configuration in which the two second traces 34A and 34B pass through one of the connecting sections 13. The smaller the difference in line length between the two second traces 34A and 34B, the smaller the frequency dependence of the phase difference between high-frequency signals supplied to the two second radiating elements 22A and 22B.

To increase the mechanical strength of the antenna module, the two connecting sections 13 may be arranged at the respective ends of the first and second plate sections 11 and 12 in the x-direction.

Next, an antenna module according to a modification of the first embodiment will be described.

In the first embodiment, the first radiating elements 21A and 21B (FIG. 1A) radiate radio waves into the space on the positive side of the z-axis among the two spaces partitioned by the plane PL1 (FIG. 1A), that is, the space on the outer side of the curved connecting sections 13. However, the first radiating elements 11A and 11B may radiate radio waves into the space on the negative side of the z-axis, that is, on the inner side of the curved connecting sections 13. In the first embodiment, the second radiating elements 22A and 22B radiate radio waves into the space on the negative side of the y-axis among the two spaces partitioned by the plane PL2 (FIG. 1A), that is, the space on the outer side of the curved connecting sections 13. However, the first radiating elements 22A and 22B may radiate radio waves into the space on the positive side of the y-axis, that is, the space on the inner side of the curved connecting sections 13.

The first embodiment adopts patch antennas as the first radiating elements 21A and 21B and the second radiating elements 22A and 22B. However, antennas other than patch antennas may be used, for example, such as dipole antennas, slot antennas, and loop antennas.

### Second Embodiment

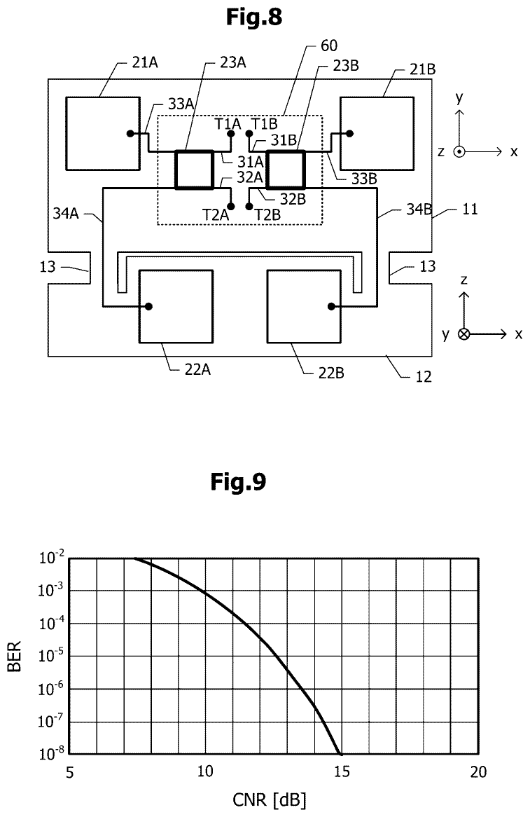

Next, an antenna module according to a second embodiment will be described with reference to FIG. 8. Hereinafter, the description about the same configurations as those of the antenna module according to the first embodiment, which is described with reference to FIGS. 1 to 7, will be omitted.

FIG. 8 is a schematic diagram illustrating the positional relationship between constituent elements when the first plate section 11, second plate section 12, and connecting sections 13 of the antenna module according to the second embodiment are individually viewed in plan view. In a similar manner to FIG. 4, the first plate section 11 is illustrated such that its direction perpendicular to the plane of the paper is parallel to the z-direction while the second plate section 12 is illustrated such that its direction perpendicular to the plane of the paper is parallel to the y-direction.

The first embodiment does not specifically define the relationship between the line lengths of the two input traces 31A and 32A and the relationship between the line lengths of the two input traces 31B and 32B. In the second embodiment, the two input traces 31A and 32A, which are connected to the hybrid circuit 23A, have the same line length, and the two input traces 31B and 32B, which are connected to the other hybrid circuit 23B, have the same line length.

The sum of the line lengths of the input trace 31A and the second trace 34A, which are connected to the hybrid circuit 23A, is equal to the sum of the line lengths of the input trace 31B and the second trace 34B, which are connected to the other hybrid circuit 23B. Furthermore, the sum of the line lengths of the input trace 31A and the first trace 33A, which are connected to the hybrid circuit 23A, is equal to the sum of the line lengths of the input trace 31B and the first trace 33B, which are connected to the other hybrid circuit 23B. That is, the two feed lines from the radio frequency integrated circuit 60 to the two first radiating elements 21A and 21B have the same line length, and the two feed lines from the radio frequency integrated circuit 60 to the two second radiating elements 22A and 22B have the same line length.

Next, the excellent effects of the second embodiment will be described.

In the second embodiment, the two input traces 31A and 32A have the same line length, and the other two input traces 31B and 32B have the same line length. Therefore, reduction of isolation between the two first radiating elements 21A and 21B and between the two second radiating elements 22A and 22B may be prevented as described with reference to FIGS. 6 and 7.

Furthermore, since the two feed lines from the radio frequency integrated circuit 60 to the two first radiating elements 21A and 21B have the same line length, the phase difference between high-frequency signals fed to the two first radiating elements 21A and 21B is maintained at a target phase difference, even if the frequencies of the high-frequency signals vary within the frequency band. Therefore, when the two first radiating elements 21A and 21B are operated as an array antenna, the frequency dependence of beamforming can be reduced. The same applies to the two second radiating elements 22A and 22B.

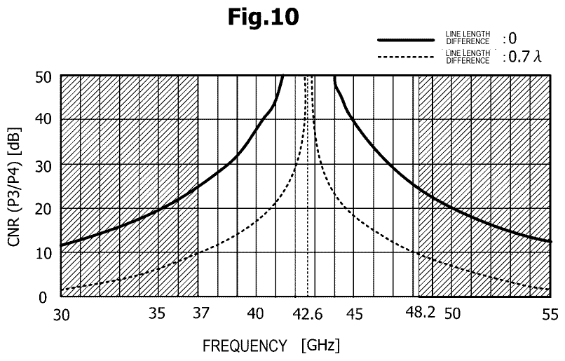

In the second embodiment, the two input traces 31A and 32A have the same line length. However, the two input traces 31A and 32A do not necessarily have the same line length. Next, with reference to FIGS. 9 and 10, the range of the difference in line length between the two input traces 31A and 32A will be described.

FIG. 9 is a graph illustrating the relationship between bit error rate (BER) and carrier-to-noise ratio (CNR) when the modulation scheme is QPSK. The horizontal axis represents CNR in units of dB, and the vertical axis represents BER. The BER is expressed by the following equation.

$$[ Math . 1 ]$$

$$BER = \frac{1}{2} erfc ( \sqrt{\frac{CNR}{2}} ) \qquad ( 1 )$$

Herein, erfc is a complementary error function.

Generally, the BER is required to be 10⁻³ or lower. To meet this requirement, the CNR may be set to approximately 10 dB or higher based on the relationship illustrated in FIG. 9. In the case of a modulation scheme that achieves a bit rate higher than QPSK, for example, such as 16QAM or 64QAM, the CNR is required to be even higher.

FIG. 10 is a graph illustrating the calculation result of the CNR of the carrier output from the output port P3 (FIG. 5) to noise output from the output port P4 (FIG. 5). The horizontal axis represents frequency in units of GHz, and the vertical axis represents CNR in units of dB. The frequency is varied in the range from 30 GHz to 55 GHz so as to include a frequency band ranging from 37 GHz to 48.2 GHz, which is used in 5G. In the graph illustrated in FIG. 10, the range other than the frequency band ranging from 37 GHz to 48.2 GHz is hatched. The center frequency of the frequency band ranging from 37 GHz to 48.2 GHz is 42.6 GHz.

The solid lines in the graph illustrated in FIG. 10 indicate the CNR when the two input traces 31A and 32A have the same line length, and the dashed lines indicate the CNR when the difference in line length between the two input traces 31A and 32A is 0.7 times the wavelength of a signal at the center frequency of 42.6 GHz. The phase difference between the signals applied to the input-output terminals T1A and T2A is adjusted so that the phase difference between the two input ports P1 and P2 is 90° at the center frequency of 42.6 GHz.

Regardless of whether there is a difference in line length, the CNR is infinite at the center frequency of 42.6 GHz and decreases as the signal frequency deviates from the center frequency. The reason why the CNR decreases even when the line lengths are equal is because the characteristics of the hybrid circuit 23A itself are frequency-dependent. When there is a difference in line length, the decrease in CNR due to deviation of the signal frequency from the center frequency is greater than that when the line lengths are equal. As the difference in line length increases, the decrease in CNR increases. This is because the phase difference between the two input ports P1 and P2 deviates from 90° due to the difference in line length.

As described with reference to FIG. 9, CNRs of 10 dB or higher may be used to ensure a suitable BER. As illustrated in FIG. 10, when the difference in line length between the two input traces 31A and 32A is not greater than 0.7 times the wavelength of a signal at the center frequency, CNRs of 10 dB or higher are ensured in a frequency band ranging from 37 GHz to 48.2 GHz. Thus, the difference in line length between the two input traces 31A and 32A may be set to not greater than 0.7 times the wavelength of a signal at the center frequency.

The line length of the transmission line connecting the two input ports P1 and P2 of the hybrid circuit 23A is one-fourth of the wavelength of a signal at the center frequency. The characteristic impedance of the transmission line connecting the two input ports P1 and P2 is equal to the characteristic impedance of the two input traces 31A and 32A. Thus, 0.7 times the wavelength of a signal at the center frequency is equal to 2.8 times the line length of the transmission line connecting the two input ports P1 and P2. Thus, the difference in line length between the two input traces 31A and 32A may be set to not greater than 2.8 times, i.e., the difference is between 0 and 2.8 times, inclusive, the line length of the transmission line connecting the two input ports P1 and P2.

### Third Embodiment

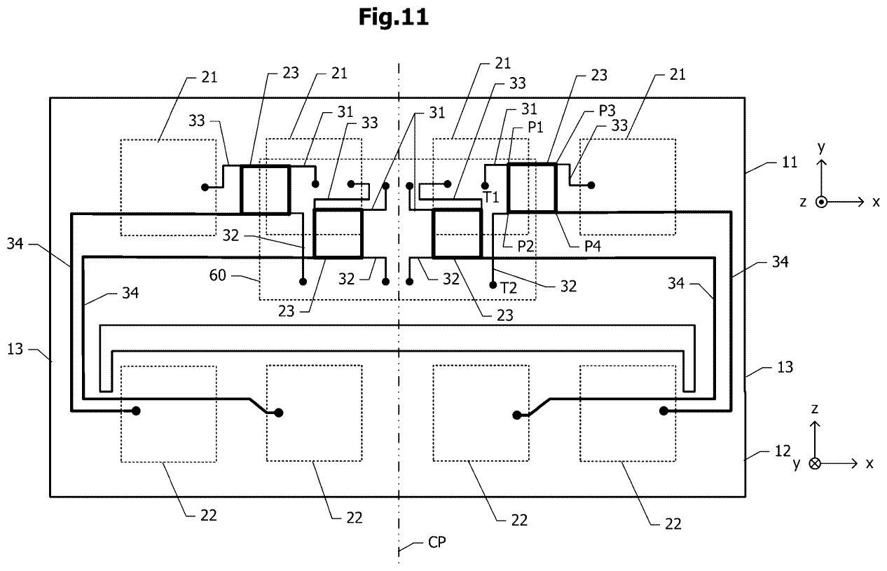

Next, an antenna module according to a third embodiment will be described with reference to FIGS. 11 to 15. Hereinafter, the description about the same configurations as those of the antenna module according to the first embodiment, which is described with reference to FIGS. 1A to 7, will be omitted.

FIG. 11 is a schematic diagram illustrating the positional relationship between constituent elements when the first plate section 11, second plate section 12, and connecting sections 13 of the antenna module according to the third embodiment are individually viewed in plan view. In a similar manner to FIG. 4, the first plate section 11 is illustrated such that its direction perpendicular to the plane of the paper is parallel to the z-direction while the second plate section 12 is illustrated such that its direction perpendicular to the plane of the paper is parallel to the y-direction.

In the first embodiment (FIG. 4), the two hybrid circuits 23A and 23B are arranged in the first plate section 11. In the third embodiment, four hybrid circuits 23 are arranged in the first plate section 11. Similarly, four first radiating elements 21 are arranged in the first plate section 11, and four second radiating elements 22 are arranged in the second plate section 12. That is, the hybrid circuits 23 are arranged for the respective plural first radiating elements 21. The four first radiating elements 21 are aligned in the x-direction to constitute an array antenna. The four second radiating elements 22 are also aligned in the x-direction to constitute another array antenna.

The two input ports P1 and P2 of each of the four hybrid circuits 23 are connected to two input-output terminals T1 and T2 of the radio frequency integrated circuit 60 through the two input traces 31 and 32, respectively. The two output ports P3 and P4 of each of the four hybrid circuits 23 are connected to the corresponding first radiating element 21 and the corresponding second radiating element 22 through the corresponding first trace 33 and the corresponding second trace 34, respectively.

The difference in line length between the two input traces 31 and 32 connected to each of the four hybrid circuits 23 is not greater than 2.8 time the line length of the transmission line connecting the two input ports P1 and P2 of the hybrid circuit 23 in a similar manner to the case of the second embodiment, which is described with reference to FIG. 10.

Two of the four hybrid circuits 23 are arranged on one side of the center plane CP while the other two hybrid circuits 23 are arranged on the other side. That is, the number of hybrid circuits 23 arranged on one side of the center plane CP is equal to the number of hybrid circuits 23 arranged on the other side.

Each of the four hybrid circuits 23 and the connecting section 13 via which the second trace 34 connected to the hybrid circuit 23 is routed are arranged on the same side of the center plane CP.

The sum of the average of the line lengths of the two input traces 31 and 32 connected to each of the plural hybrid circuits 23 and the line length of the first trace 33 is the same across the plural hybrid circuits 23. The sum of the average of the line lengths of the two input traces 31 and 32 connected to each of the plural hybrid circuits 23 and the line length of the second trace 34 is the same across the plural hybrid circuits 23.

Next, the excellent effects of the third embodiment will be described.

In the third embodiment, since the sum of the average of the line lengths of the two input traces 31 and 32 and the line length of the first trace 33 is the same across the plural hybrid circuits 23, the phase relationship between signals fed to the plural first radiating elements 21 remains unchanged even if the signal frequency varies within a predetermined frequency band. Therefore, when the plural first radiating elements 21 are operated as an array antenna, the frequency dependence of beamforming is reduced, allowing for stable beamforming. Furthermore, when the plural second radiating elements 22 are operated as an array antenna, stable beamforming can also be implemented in a similar manner.

Furthermore, each of the four hybrid circuits 23 and the connecting section 13 via which the second trace 34 connected to the hybrid circuit 23 is routed are located on the same side of the center plane CP. This facilitates the design of the wiring layout in which the sum of the average of the line lengths of the two input traces 31 and 32 and the line length of the second trace 34 is the same across the plural hybrid circuits 23.

Next, an antenna module according to a modification of the third embodiment will be described.

In the third embodiment, the four hybrid circuits are arranged in the first plate section 11. However, three, five, or more hybrid circuits 23 may be arranged in the first plate section 11. For each of the plural hybrid circuits 23, one first radiating element 21 and one second radiating element 22 are arranged. When the number of hybrid circuits 23 is even, the number of hybrid circuits 23 arranged on one side of the center plane CP and the number of hybrid circuits 23 arranged on the other side may be equal. When the number of hybrid circuits 23 is odd, the number of hybrid circuits 23 arranged on one side of the center plane CP and the number of hybrid circuits 23 arranged on the other side may differ by one.

Next, other modifications of the third embodiment will be described. In the third embodiment, the sum of the average of the line lengths of the two input traces 31 and 32 and the line length of the first trace 33 is the same across the plural hybrid circuits 23. However, if the difference between these sums is not greater than an allowable upper limit, these sums do not need to be the same. Similarly, the sum of the average of the line lengths of the two input traces 31 and 32 and the line length of the second trace 34 does not need to be the same across the plural hybrid circuits 23.

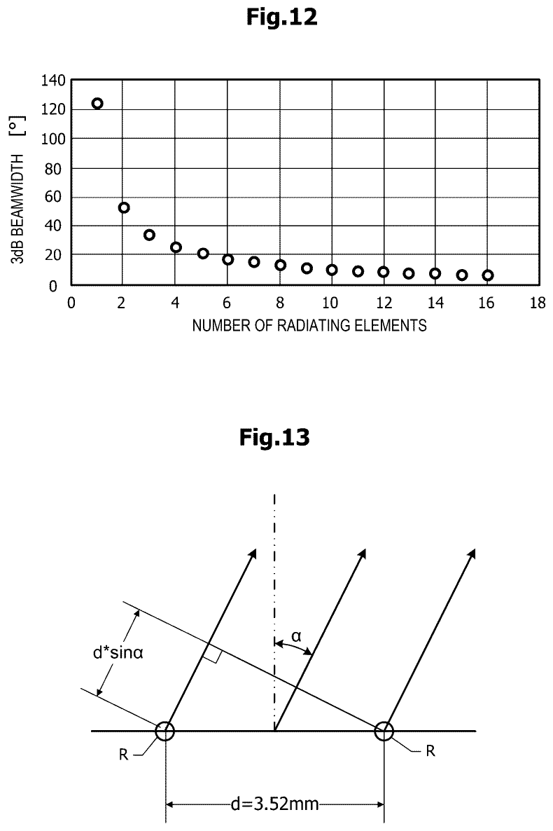

Next, the allowable upper limit of the difference between these sums is described with reference to FIGS. 12, 13, 14, and 15.

When plural radiating elements are operated as an antenna array for beamforming, variation in signal frequency within the operating frequency band causes a change in phase difference between signals at the feed points of two adjacent radiating elements, among the plural radiating elements, due to differences in line length between the feed lines to the plural radiating elements, resulting in a change in beam direction.

A 3 dB beamwidth BW of a linear array antenna can be approximately expressed by the following equation using the number N of radiating elements, distance d between centers of the radiating elements, and signal wavelength λ₀ in vacuum.

$$[ Math . 2 ]$$

$$BW = 2 {sin}^{- 1} ( \frac{1.391 {λ}_{θ}}{π Nd} ) \qquad ( 2 )$$

Equation (2) accounts for an array factor that neglects the directivity of each radiating element.

FIG. 12 is a graph illustrating the relationship between the number N of radiating elements constituting a linear array antenna and 3 dB beamwidth BW. The horizontal axis represents the number N of radiating elements, and the vertical axis represents the 3 dB beamwidth BW in units of °. The wavelength λ₀ is the wavelength in vacuum of radio waves at the center frequency of 42.6 GHz of the frequency band illustrated in FIG. 10. The distance d between the centers of the plural radiating elements is set to one-half of the wavelength λ₀. As the number N of radiating elements increases, the 3 dB beamwidth BW decreases.

FIG. 13 is a schematic diagram illustrating the relationship between two radiating elements R and the beam direction. The following equation approximately holds:

$$d sin α = {λ}_{0} \frac{Δϕ}{2 π} \qquad ( 3 )$$

where Δφ is the phase difference between signals applied to the two radiating elements R and a is the angle between the normal direction to the straight line connecting the two radiating elements R and the beam direction.

Next, the results of analyzing the influence of the difference between line lengths of feed lines on the beam direction will be described. As the analysis conditions, the phase difference between the signals applied to input ends of the feed lines is adjusted so as to produce a phase difference of Δφ between the signals at the feed points of the two radiating elements R at the center frequency of 42.6 GHz. The beam direction at this time is referred to as a reference beam direction.

At the frequencies of 37 GHz at the lower end of the frequency band illustrated in FIGS. 10 and 48.2 GHz at the upper end, the phase difference at the feed points of the two radiating elements R deviates from Op due to the difference in line length between the feed lines. Due to this deviation of the phase difference, the beam direction deviates from the reference beam direction. The beam direction deviates in opposite directions at the frequencies of 37 GHz at the lower end of the frequency band and 48.2 GHz at the upper end.

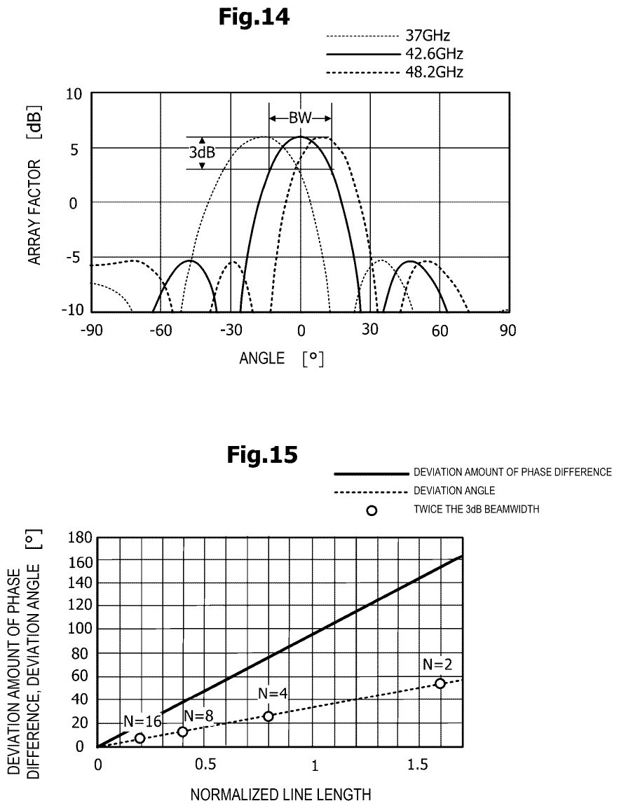

FIG. 14 is a graph illustrating the array factor of a four-element array antenna. The horizontal axis represents angle in units of °, and the vertical axis represents the array factor in units of dB. The thin dashed line, solid line, and thick dashed line in the graph indicate array factors at frequencies of 37, 42.6 and 48.2 GHz, respectively.

The beam direction (the reference beam direction) at the center frequency of 42.6 GHz is defined as 0°. FIG. 14 reveals that the beam direction at the frequency of 37 GHz at the lower end and the beam direction at the frequency of 48.2 GHz at the upper end deviate in opposite directions from the reference beam direction. The 3 dB beamwidth BW is approximately 27°.

When the angle of deviation between the beam direction at the frequency of 37 GHz at the lower end of the frequency band illustrated in FIG. 10 and the beam direction at the frequency of 48.2 GHz at the upper end is not greater than the 3 dB beamwidth, the decrease in array factor in the reference beam direction is substantially smaller than 3 dB. Accordingly sufficient communication quality can be ensured in the reference beam direction. Thus, the angle of deviation in the beam direction between the upper and lower ends of the operating frequency band of the antenna module may not be greater than the 3 dB beamwidth.

FIG. 15 is a graph illustrating the relationship between the difference in line length between feed lines and the amount of deviation in the phase difference, as well as the relationship between the difference in line length between feed lines and the angle of deviation in the beam direction. The horizontal axis represents normalized line length difference, which is obtained by normalizing the difference in line length between feed lines based on one-half of the wavelength in vacuum at the center frequency of 42.6 GHz, that is, 3.52 mm. The vertical axis represents angle in units of °. The solid line in the graph of FIG. 15 indicates the amount of deviation in the phase difference between the feed points when the antenna module operates at frequencies at upper and lower ends of the operating frequency band, and the dashed line indicates the angle of deviation in the beam direction.

As the difference in line length between feed lines increases, the amount of deviation in the phase difference increases, and therefore the angle of deviation in the beam direction increases. In FIG. 15, circle symbols are illustrated at positions of angle of deviations in the beam direction corresponding to the 3 dB beamwidth BW when the number N of the radiating elements R is 2, 4, 8, and 16.

When the number N of radiating elements R is 4 and the normalized line length difference is 0.8 or more, for example, the angle of deviation in the beam direction is greater than or equal to the 3 dB beamwidth BW between the frequencies at the lower and upper ends of the frequency band. In order to keep the angle of deviation in the beam direction smaller than or equal to the 3 dB beamwidth BW, the normalized line length difference may be smaller than or equal to 0.8.

More generally, the normalized line length difference may be smaller than or equal to 3.2/N where N is the number of radiating element R. Since the line length of the transmission line connecting the two input ports P1 and P2 of each hybrid circuit 23 (FIG. 11) is one-fourth of the wavelength, the difference in line length between the feed lines to adjacent radiating elements R may not be greater than a value obtained by dividing 12.8 times the line length of the transmission line connecting the two input ports P1 and P2 of the hybrid circuit 23, by the number N of radiating elements R.

The above considerations concerning the plural radiating elements R apply to an array antenna composed of plural first radiating elements 21 and an array antenna composed of plural second radiating elements 22. In this case, the difference in line length between feed lines corresponds to the difference in the sum of the average of the line lengths of the two input traces 31 and 32 connected to each of the plural hybrid circuits 23 and the line length of the first trace 33 and the difference in the sum of the average of the line lengths of the two input traces 31 and 32 connected to each of the plural hybrid circuits 23 and the line length of the second trace 34.

### Fourth Embodiment

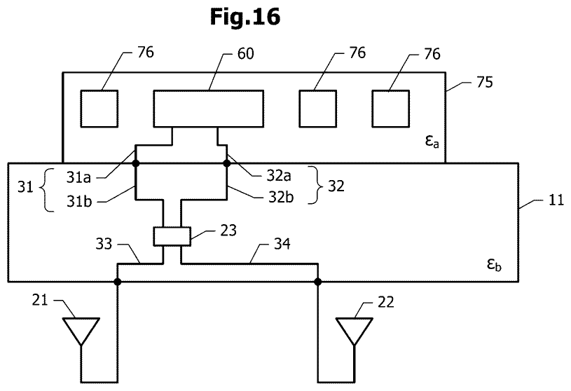

Next, an antenna module according to a fourth embodiment will be described with reference to FIG. 16. Hereinafter, the description about the same configurations as those of the antenna module according to the first embodiment, which is described with reference to FIGS. 1A to 7, will be omitted.

FIG. 16 is a schematic diagram illustrating a schematic sectional structure of the antenna module according to the fourth embodiment. In the first embodiment (FIGS. 1A and 4), the radio frequency integrated circuit 60 is directly mounted on the first plate section 11. On the other hand, the antenna module according to the fourth embodiment includes a system-in-package module (SiP module) 75, in which the radio frequency integrated circuit 60 and other plural circuit components 76 (electronic components) are mounted. This SiP module 75 is mounted on the first plate section 11. Examples of the plural circuit components 76 are a power control integrated circuit, an integrated passive component, a capacitor, and an inductor.

The radio frequency integrated circuit 60 is connected to a hybrid circuit 23, which is located in the first plate section 11, through two input traces 31 and 32. The input trace 31 includes a wiring portion 31a inside the SiP module 75 and a wiring portion 31b inside the first plate section 11. The other input trace 32 includes a wiring portion 32a inside the SiP module 75 and a wiring portion 32b inside the first plate section 11. The dielectric constant of the dielectric member supporting the wiring portions 31a and 32a inside the SiP module 75 is expressed by εₐ, and the dielectric constant of the dielectric member supporting the wiring portions 31b and 32b inside the first plate section 11 is expressed by ε_{b}.

The hybrid circuit 23 is connected to a first radiating element 21 through a first trace 33 and is connected to a second radiating element 22 through a second trace 34.

Next, the relationship between line lengths of the wiring portions 31a and 31b of the input trace 31 and the wiring portions 32a and 32b of the input traces 32 when the dielectric constants εₐ and ε_{b} are equal will be described. As described with reference to FIGS. 6 and 7, the difference in line length between the two input traces 31 and 32 should be minimized. To meet this requirement, the antenna module may have a configuration in which the magnitude relationship in length between the wiring portions 31a and 32a of the two input traces 31 and 32, which are located inside the SiP module 75, is reversed to the magnitude relationship in length between the wiring portions 31b and 32b, which are located inside the first plate section 11, between the two input traces 31 and 32.

Next, cases where the dielectric constants εₐ and ε_{b} are different will be described.

As the dielectric constant of a dielectric member around a trace increases, the wavelength of the signal transmitted through the trace decreases under the conditions of constant frequency. The difference in line length of traces is thereby prominently reflected on the phase difference. To reduce the difference in electrical length of the two input traces 31 and 32, when εₐ>ε_{b}, the difference in line length between the wiring portions 31a and 32a may be smaller than the difference in line length between the wiring portions 31b and 32b. When εₐ<ε_{b}, the difference in line length between the wiring portions 31b and 32b may be smaller than the difference in line length between the wiring portions 31a and 32a. That is, the difference in line length between two wiring portions supported by a dielectric member with the higher dielectric constant may be smaller than the difference in line length between two wiring portions supported by a dielectric member with the lower dielectric constant.

Next, the excellent effects of the fourth embodiment will be described.

Even in the configuration in which the radio frequency integrated circuit 60 is included in the SiP module 75 like the fourth embodiment, reduction of isolation between the first radiating element 21 and the second radiating element 22 may be prevented.

### Fifth Embodiment

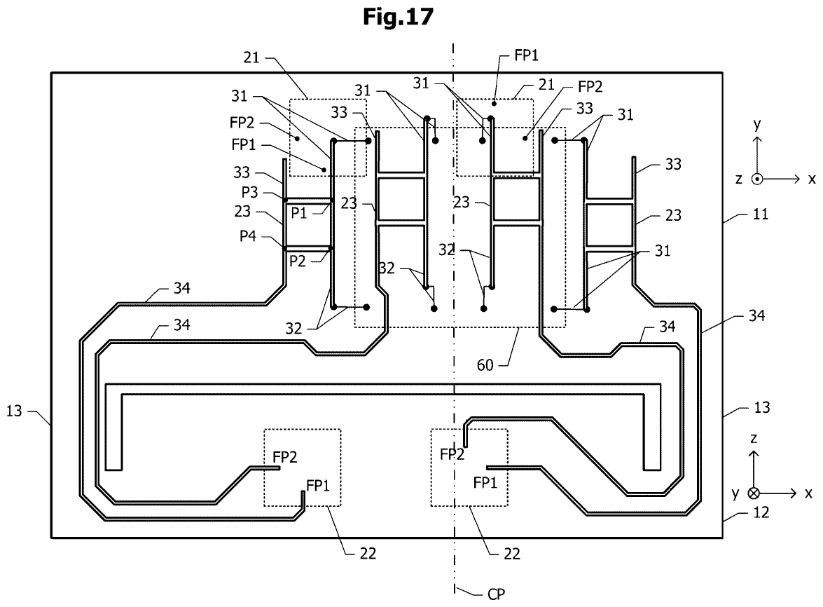

Next, an antenna module according to a fifth embodiment will be described with reference to FIG. 17. Hereinafter, the description about the same configurations as those of the antenna module according to the first embodiment, which is described with reference to FIGS. 1A to 7, will be omitted.

FIG. 17 is a schematic diagram illustrating the positional relationship between constituent elements in plan view of the first plate section 11, second plate section 12, and connecting sections 13 of the antenna module according to the fifth embodiment. In a similar manner to FIG. 4, the first plate section 11 is illustrated such that its direction perpendicular to the plane of the paper is parallel to the z-direction while the second plate section 12 is illustrated such that its direction perpendicular to the plane of the paper is parallel to the y-direction.

In the first embodiment (FIG. 4), the plural first radiating elements 21A and 21B and the plural second radiating elements 22A and 22B each include a single feed point FP. In the fifth embodiment, the plural first radiating elements 21 and plural second radiating elements 22 each include two feed points FP1 and FP2.

In each of the plural first radiating elements 21 and the plural second radiating elements 22, the polarization direction of radio waves when power is fed to the feed point FP1 and the polarization direction of radio waves when power is fed to the feed point FP2 are different from each other and have, for example, an orthogonal relationship. The polarization directions of radio waves radiated by the plural first radiating elements 21 when power is fed to the feed points FP1 of the plural first radiating elements 21 are parallel to each other. The polarization directions of radio waves radiated by the plural first radiating elements 21 when power is fed to the feed points FP2 of the plural first radiating elements 21 are parallel to each other. The same applies to the two feed points FP1 and FP2 of each of the plural second radiating elements 22.

For each of the feed points FP1 and FP2 of the plural first radiating elements 21, one hybrid circuit 23 is arranged. That is, the number of hybrid circuits 23 is twice the number of first radiating elements 21.

The two feed points FP1 and FP2 of the plural first radiating elements 21 are each connected to the output port P3 of the corresponding hybrid circuit 23 through the corresponding first trace 33. FIG. 17 illustrates only a part of each first trace 33. The two feed points FP1 and FP2 of the plural second radiating elements 22 are each connected to the output port P4 of the corresponding hybrid circuit 23 through the corresponding second trace 34.

The number of hybrid circuits 23 arranged on one side of the center plane CP is equal to the number of hybrid circuits 23 arranged on the other side. The two hybrid circuits 23 connected to the two feed points FP1 and FP2 of one first radiating element 21 are arranged on the same side of the center plane CP.

The positional relationship between the plural hybrid circuits 23 and the radio frequency integrated circuit 60 in plan view of the first plate section 11 is similar to that in the first embodiment (FIG. 4). The relationship between the line lengths of the two input traces 31 and 32, which are connected to each of the plural hybrid circuits 23, is similar to that in the first, second, or third embodiment. Thus, reduction of isolation between the plural first radiating elements 21 and the plural second radiating elements 22 may be prevented, in a similar manner to the first, second, or third embodiment.

The conditions relating to the difference in the sum of the line length of each of the plural first traces 33 connected to the respective feed points FP1 of the plural first radiating elements 21, and the average of the line lengths of the two input traces 31 and 32 connected to the corresponding first trace 33 are the same as the conditions in the first or second embodiment. This can reduce the frequency dependence of beamforming when power is fed to the feed points FP1 of the plural first radiating elements 21 to operate the plural first radiating elements 21 as an array antenna. The same applies to the other feed point FP2 of each of the plural first radiating elements 21.

The conditions relating to the difference in the sum of the line length of each of the plural second traces 34 connected to the respective feed points FP1 of the plural second radiating elements 22, and the average of the line lengths of the two input traces 31 and 32 connected to the corresponding second trace 34 are the same as the conditions in the first or second embodiment. This can reduce the frequency dependence of beamforming when power is fed to the feed points FP1 of the plural second radiating elements 22 to operate the plural second radiating elements 22 as an array antenna. The same applies to the other feed point FP2 of each of the plural second radiating elements 22.

The plural first radiating elements 21 can radiate circularly-polarized radio waves when power is simultaneously fed to the two feed points FP1 and FP2 of each of the plural first radiating elements 21. In this case, the conditions relating to the difference in the sum of the line length of each of the plural first traces 33, which are connected to the respective feed points FP1 and FP2 of the plural first radiating elements 21, and the average of the line lengths of the two input traces 31 and 32 connected to the corresponding first trace 33 are the same as the conditions in the first or second embodiment. This can reduce the frequency dependence of beamforming when power is simultaneously fed to both the feed points FP1 and FP2 of the plural first radiating elements 21 to operate the plural first radiating elements 21 as an array antenna.

Similarly for the plural second radiating elements 22, the conditions relating to the difference in the sum of the line length of each of the plural second traces 34, which are connected to the respective feed points FP1 and FP2 of the plural second radiating elements 22, and the average of the line lengths of the two input traces 31 and 32 connected to the corresponding second trace 34 are the same as the conditions in the first or second embodiment.

Next, the excellent effects of the fifth embodiment will be described.

The antenna module of the fifth embodiment can transmit and receive two types of linearly-polarized waves with different polarization directions. Furthermore, the antenna module of the fifth embodiment can transmit and receive circularly-polarized waves.

### Sixth Embodiment

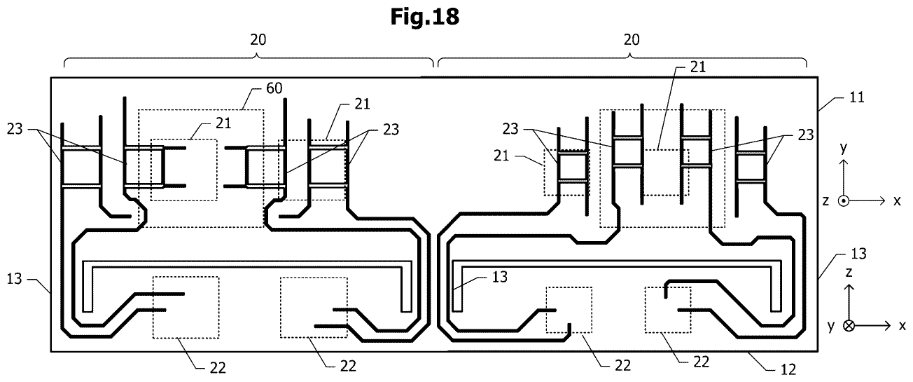

Next, an antenna module according to a sixth embodiment will be described with reference to FIG. 18. Hereinafter, the description about the same configurations as those of the antenna module according to the fifth embodiment, which is described with reference to FIG. 17, will be omitted.

FIG. 18 is a schematic diagram illustrating the positional relationship between constituent elements when the first plate section 11, second plate section 12, and connecting sections 13 of the antenna module according to the sixth embodiment are individually viewed in plan view. In a similar manner to FIG. 17, the first plate section 11 is illustrated such that its direction perpendicular to the plane of the paper is parallel to the z-direction while the second plate section 12 is illustrated such that its direction perpendicular to the plane of the paper is parallel to the y-direction.

The antenna module according to the sixth embodiment includes plural, for example, two circuit units 20. The basic circuit configuration of each of the plural circuit units 20 is the same as the circuit configuration of the antenna module according to the fifth embodiment. That is, each of the plural circuit units 20 includes the radio frequency integrated circuit 60, plural first radiating elements 21, plural second radiating elements 22, plural hybrid circuits 23, and plural traces connecting these components. The plural circuit units 20 are aligned in the x-direction.

The plural first radiating elements 21 and the plural hybrid circuits 23 of the plural circuit units 20 are arranged in the same first plate section 11. The plural second radiating elements 22 of the plural circuit units 20 are arranged in the same second plate section 12.

Each of the plural circuit units 20 corresponds to two connecting sections 13. One connecting section 13 may be shared by two circuit units 20 arranged on both sides thereof in the x-direction.

The operating frequency bands of the two circuit units 20 are different. For example, the operating frequency bands of the plural first radiating elements 21 and the plural second radiating elements 22 included in one circuit unit 20 are the same. However, the operating frequency bands of the plural first radiating elements 21 and the plural second radiating elements 22 differ between the circuit units 20. The dimensions of the plural first radiating elements 21, plural second radiating elements 22, and plural hybrid circuits 23 of the circuit unit 20 operating in a relatively low-frequency band are greater than the dimensions of the plural first radiating elements 21, plural second radiating elements 22, and plural hybrid circuits 23 of the circuit unit 20 operating in a relatively high-frequency band. Furthermore, the spacing between the centers of the plural first radiating elements 21 and the spacing between the centers of the plural second radiating elements 22 in the circuit unit 20 operating in a low-frequency band are wider than those in the circuit unit 20 operating in a high-frequency band, respectively.

Next, the excellent effects of the sixth embodiment will be described.

The antenna module according to the sixth embodiment is able to operate in multiple frequency bands.

### Seventh Embodiment

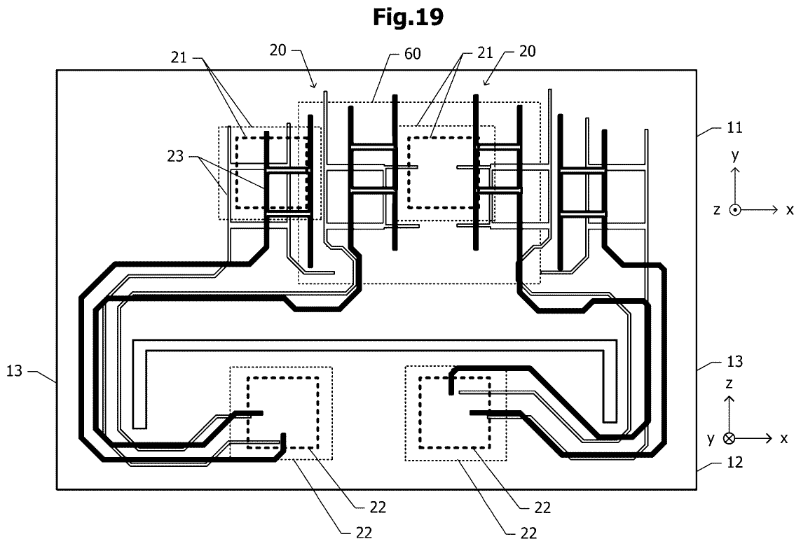

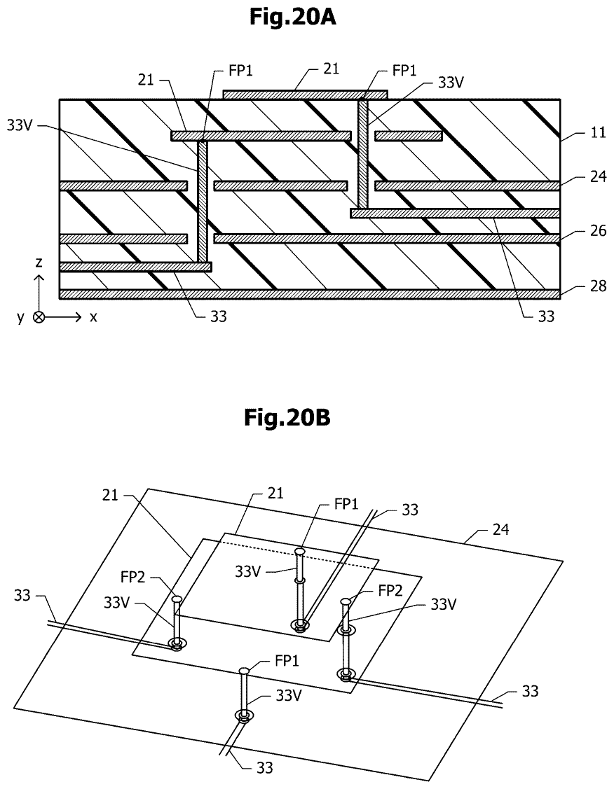

Next, an antenna module according to a seventh embodiment will be described with reference to FIGS. 19, 20A, and 20B. Hereinafter, the description about the same configurations as those of the antenna module according to the sixth embodiment, which is described with reference to FIG. 18, will be omitted.

FIG. 19 is a schematic diagram illustrating the positional relationship between constituent elements when the first plate section 11, second plate section 12, and connecting sections 13 of the antenna module according to the seventh embodiment are individually viewed in plan view. In a similar manner to FIG. 18, the first plate section 11 is illustrated such that its direction perpendicular to the plane of the paper is parallel to the z-direction while the second plate section 12 is illustrated such that its direction perpendicular to the plane of the paper is parallel to the y-direction.

In the sixth embodiment, the plural circuit units 20 (FIG. 18) are aligned in the x-direction. In the seventh embodiment, the plural circuit units 20 are arranged to at least partially overlap in plan view of the first plate section 11 and in plan view of the second plate section 12.

For example, in plan view of the first plate section 11, the plural first radiating elements 21 of one of the circuit units 20 respectively overlap the plural first radiating elements 21 of the other circuit unit 20. The first radiating elements 21 of the circuit unit 20 operating in a high-frequency band may be included in the respective first radiating elements 21 of the circuit unit 20 operating in a low-frequency band. The positional relationship between the plural second radiating elements 22 are similar to the positional relationship between the plural first radiating elements 21.

In plan view of the first plate section 11, at least one of the plural hybrid circuits 23 of one of the circuit units 20 partially overlaps any one of the plural hybrid circuits 23 of the other circuit unit 20. The radio frequency integrated circuit 60 is shared by the two circuit units 20.

FIGS. 20A and 20B are respectively a sectional view and a perspective view of two first radiating elements 21 overlapping each other along the z-direction. The configuration of two second radiating elements 22 overlapping each other is the same as that of the two first radiating elements 21 overlapping each other.

The first radiating element 21 of the circuit unit 20 with a relatively high-frequency band is arranged on the surface of the first plate section 11 facing the positive side of the z-axis, and the first radiating element 21 of the circuit unit 20 with a relatively low-frequency band is arranged in an inner layer. The first radiating element 21 of the circuit unit 20 with a relatively high-frequency band may be arranged in an inner layer at a shallower position than the first radiating element 21 of the circuit unit 20 with a relatively low-frequency band.

In plan view, the first radiating element 21 with a high-frequency band is included in the respective first radiating element 21 with a low-frequency band. An antenna that has such a configuration and operates in two frequency bands is sometimes called a stacked multiband antenna. The ground conductor 24 is arranged at a deeper position than the first radiating element 21 with a low-frequency band, and another ground conductor 26 is arranged at a deeper position than the ground conductor 24. Yet another ground conductor 28 is arranged at an even deeper position. In FIG. 20B, the ground conductors 26 and 28 are not illustrated.

Plural first traces 33 are arranged between the ground conductors 24 and 26 and between the ground conductors 26 and 28. Each first trace 33 and the ground conductors arranged above and below the same constitute a stripline. Via conductors 33V extend from the respective two feed points FP1 and FP2 of the first radiating element 21 with a high frequency band toward the inner layer side and penetrate the first radiating element 21 with a low frequency band and the ground conductor 24 to be connected to the first traces 33 between the ground conductors 24 and 26. Other via conductors 33V extend from the respective two feed points FP1 and FP2 of the first radiating element 21 with a low frequency band toward the inner layer side and penetrate the ground conductors 24 and 26 to be connected to the first traces 33 between the ground conductors 26 and 28. Each via conductor 33V constitutes a part of the first traces 33.

The hybrid circuits 23 with a high-frequency band, not illustrated in FIG. 20A, are arranged between the ground conductors 24 and 26. Furthermore, the hybrid circuits 23 with a low-frequency band are arranged between the ground conductors 26 and 28.

Next, the excellent effects of the seventh embodiment will be described.

In the seventh embodiment, the antenna module is able to operate in multiple frequency bands in a similar manner to the sixth embodiment. Furthermore, according to the seventh embodiment, the antenna module can be miniaturized, compared to the sixth embodiment.

Next, a modification of the seventh embodiment will be described.

The seventh embodiment uses a stacked multiband antenna but may use a multiband antenna having another configuration. For example, the multiband antenna illustrated in FIG. 9 of Japanese Patent No. 6923853 publication may be used.

In the seventh embodiment, the region where the plural hybrid circuits 23 of one of the circuit units 20 are arranged and the region where the plural hybrid circuits 23 of the other circuit units 20 are arranged overlap each other. However, the plural hybrid circuits 23 of the plural circuit units 20 may be arranged in the same wiring layer so as not to overlap each other.

In the seventh embodiment, the antenna module has a configuration in which the two circuit units 20 overlap in plan view. However, the antenna module may adopt a configuration in which three or more circuit units 20 operating in different frequency bands overlap in plan view.

### Eighth Embodiment

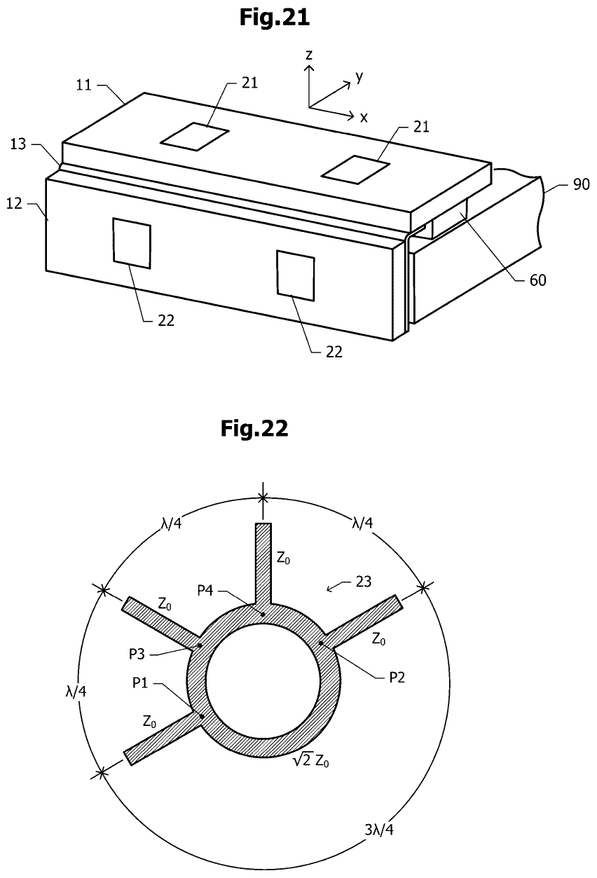

Next, an antenna module according to an eighth embodiment will be described with reference to FIG. 21. Hereinafter, the description about the same configurations as those of the antenna module according to the first embodiment, which is described with reference to FIGS. 1 to 7, will be omitted.

FIG. 21 is a perspective view of the antenna module according to the eighth embodiment. In the first embodiment (FIG. 1A), the connecting sections 13 are arranged at two locations, spaced apart in the x-direction. In the eighth embodiment, a single connecting section 13 connects the first plate section 11 to the second plate section 12. The connecting section 13 is composed of a thinner plate-shaped member than the first and second plate sections 11 and 12. The antenna module can be produced by bonding the plate-shaped connecting section 13 to the first and second plate sections 11 and 12 and then curving the connecting section 13.

Next, the excellent effects of the eighth embodiment will be described.

The antenna module may include a single connecting section 13 like the eighth embodiment. To ensure sufficient mechanical strength, the connecting section 13 may be arranged from one end of the first and second plate sections 11 and 12 in the x-direction to the other end. Such an arrangement of the connecting section 13 can increase the flexibility of the wiring layout of the second traces 34 (FIG. 4) connecting the hybrid circuits 23 (FIG. 4) to the second radiating elements 22.

### Ninth Embodiment

Next, an antenna module according to a ninth embodiment will be described with reference to FIG. 22. Hereinafter, the description about the same configurations as those of the antenna module according to the first embodiment, which is described with reference to FIGS. 1A to 9, will be omitted.

FIG. 22 is a schematic plan view of a hybrid circuit 23 used in the antenna module according to the ninth embodiment. In FIG. 22, the transmission line is hatched. In the first embodiment (FIG. 2), the hybrid circuits 23A and 23B, which connect the first radiating elements 21A and 21B and the second irradiating elements 22A and 22B to the radio frequency integrated circuit 60 are branch-type hybrid circuits. On the other hand, the ninth embodiment adopts a rat-race hybrid circuit 23.

The rat-race hybrid circuit 23 includes two input ports P1 and P2 and two output ports P3 and P4 on a circumferential transmission line (a loop transmission line). The characteristic impedance of the loop transmission line is the square root of two times a characteristic impedance Z₀ of the input-output transmission line connected to the input ports P1 and P2 and the output ports P3 and P4. The line length of the loop transmission line is 1.5 times the wavelength λ of the high-frequency signal with a specific frequency within the operating frequency band.

The output port P3, output port P4, and input port P2 are located at (¼)λ, ( 2/4)λ, and (¾)λ clockwise from the input port P1 on the loop transmission line, respectively. When high-frequency signals having a phase difference of 90° are input to the input ports P1 and P2, a high-frequency signal is output from one of the output ports P3 and P4 while no high-frequency signal is output from the other port. The input-output relationship of high-frequency signals concerning the input ports P1 and P2 and output ports P3 and P4 is the same as that of the hybrid circuits 23A and 23B in the first embodiment (FIG. 2).

The connection relationship between the input and output ports P1, P2, P3, and P4 and the first radiating elements 21A and 21B, second radiating elements 22A and 22B, and radio frequency integrated circuit 60 is the same as that in the first embodiment (FIG. 2). The layout of the traces connecting these components is the same as that in the first embodiment (FIG. 2).

Next, the excellent effects of the ninth embodiment will be described. In the ninth embodiment, the layout of the elements and traces that prevents reduction of isolation between the first and second radiating elements 21A and 22A (FIG. 4) may be facilitated in a similar manner to the first embodiment.

### 10th Embodiment

Next, an antenna module according to a 10th embodiment will be described with reference to FIG. 23. Hereinafter, the description about the same configurations as those of the antenna module according to the first embodiment, which is described with reference to FIGS. 1A to 9, will be omitted.

FIG. 23 is a schematic plan view of a hybrid circuit 23 used in the antenna module according to the 10th embodiment. In FIG. 23, the transmission line is hatched. In the first embodiment (FIG. 2), each of the hybrid circuits 23A and 23B is a 90° hybrid circuit. In the 10th embodiment, each of the hybrid circuits 23A and 23B is a hybrid circuit 23 having a configuration in which two 90° hybrid circuits are merged.

The hybrid circuit 23 according to the 10th embodiment includes a transmission line along the perimeter of a rectangle with a short side length of (¼)λ and a long side length of (½)λ and a shunt transmission line connecting the midpoints of the long sides of the rectangle. The respective ends of one short side of the rectangle correspond to the input ports P1 and P2, the respective ends of one long side correspond to the input port P1 and the output port P3, and the respective ends of the other long side correspond to the input port P2 and the output port P4.

The input ports P1 and P2 and the output ports P3 and P4 are connected to the respective input-output transmission lines. The characteristic impedances of these input-output transmission lines are, for example, 50Ω. The characteristic impedances of the transmission lines along the short sides of the rectangle are 120.8Ω, and the characteristic impedances of the transmission lines along the long sides and the shunt transmission line are 35.4Ω.

The input-output relationship between high-frequency signals concerning the input ports P1 and P2 and the output ports P3 and P4 of the hybrid circuit 23 of the antenna module according to the 10th embodiment is the same as that of the hybrid circuits 23A and 23B of the first embodiment (FIG. 2). The connection relationship between the input and output ports P1, P2, P3, and P4 and the first radiating elements 21A and 21B, second radiating elements 22A and 22B, and radio frequency integrated circuit 60 is the same as that in the first embodiment (FIG. 2). The layout of traces connecting these components is the same as that in the first embodiment (FIG. 2).

Next, the excellent effects of the 10th embodiment will be described. In the 10th embodiment, the layout of elements and traces that prevents reduction of isolation between the first and second radiating elements 21A and 22A (FIG. 4) may be facilitated in a similar manner to the first embodiment. Furthermore, in the 10th embodiment, the hybrid circuit 23 has a configuration in which two 90° hybrid circuits are merged, whereby the frequency band of the antenna module can be widened.

### 11th Embodiment

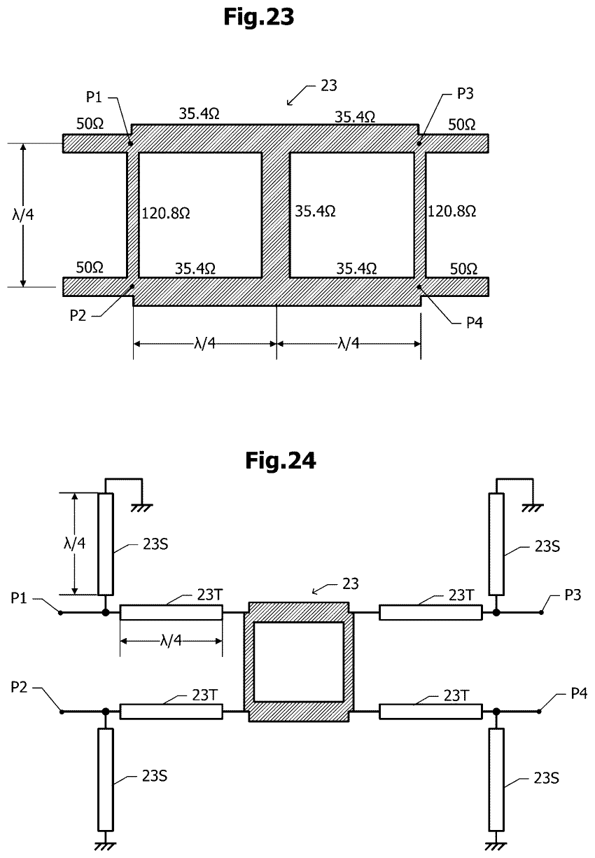

Next, an antenna module according to an 11th embodiment will be described with reference to FIG. 24. Hereinafter, the description about the same configurations as those of the antenna module according to the first embodiment, which is described with reference to FIGS. 1A to 9, will be omitted.

FIG. 24 is an equivalent circuit diagram of a hybrid circuit 23 used in the antenna module according to the 11th embodiment and transmission lines connected to the hybrid circuit 23. In the first embodiment (FIG. 2), the respective four nodes of each of the hybrid circuits 23A and 23B correspond to the input ports P1 and P2 and the output ports P3 and P4.

In the 11th embodiment, transmission lines 23T each having a line length of (¼)λ are connected between the four nodes of the hybrid circuit 23 and the two input ports P1 and P2 and two output ports P3 and P4. Furthermore, a short-circuited stub 23S having a line length of (¼)λ is connected to each of the two input ports P1 and P2 and two output ports P3 and P4.

The input-output relationship between high-frequency signals concerning the input ports P1 and P2 and output ports P3 and P4 of the hybrid circuit 23 of the antenna module according to the 11th embodiment is the same as that of the hybrid circuits 23A and 23B of the first embodiment (FIG. 2). The connection relationship between the input and output ports P1, P2, P3, and P4 and the first radiating elements 21A and 21B, second radiating elements 22A and 22B, and radio frequency integrated circuit 60 is the same as that in the first embodiment (FIG. 2). The layout of traces connecting these components is the same as that in the first embodiment (FIG. 2).

Next, the excellent effects of the 11th embodiment will be described. In the 11th embodiment, the layout of elements and traces that prevents reduction of isolation between the first and second radiating elements 21A and 22A (FIG. 4) may be facilitated in a similar manner to the first embodiment. Furthermore, in the 11th embodiment, arranging the transmission lines 23T and the short-circuited stubs 23S can widen the frequency band of the antenna module.

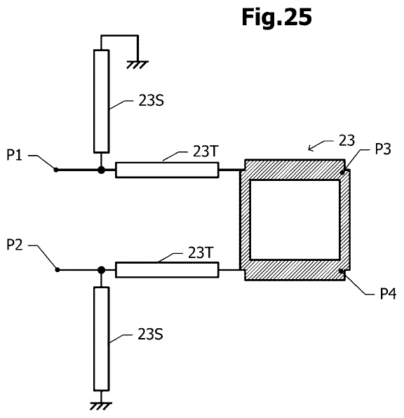

Next, an antenna module according to a modification of the 11th embodiment will be described with reference to FIG. 25.

FIG. 25 is an equivalent circuit diagram of a hybrid circuit 23 used in the antenna module according to the modification of the 11th embodiment and transmission lines connected to the hybrid circuit 23. In the 11th embodiment (FIG. 24), each of the two input ports P1 and P2 and the two output ports P3 and P4 is provided with a transmission line 23T and a short-circuited stub 23S. In the modification illustrated in FIG. 25, each of the two input ports P1 and P2 is provided with a transmission line 23T and a short-circuited stub 23S while the two output ports P3 and P4 are not provided with any transmission line 23T or short-circuited stub 23S. That is, two nodes of the hybrid circuit 23 are individually used as the output ports P3 and P4.

Even when the transmission lines 23T and the short-circuited stubs 23S are arranged only on the input side of the hybrid circuit 23 like the modification illustrated in FIG. 25, the effect of widening the bandwidth can be achieved. In a similar manner, even when the transmission lines 23T and the short-circuited stubs 23S are arranged only on the output side of the hybrid circuit 23, the effect of widening the bandwidth can be achieved.

The aforementioned embodiments are illustrative, and it is obvious that the configurations illustrated in different embodiments can be partially replaced or combined. Similar operation effects resulting from similar configurations of plural embodiments are not repeatedly described for each embodiment. Furthermore, the present disclosure is not limited by the aforementioned embodiments. For example, it is apparent to those skilled in the art that various modifications, improvements, combinations, and the like can be made, for example.

### REFERENCE SIGNS LIST

11 FIRST PLATE SECTION
12 SECOND PLATE SECTION
12E EXTENSION PORTION OF SECOND PLATE SECTION
13 CONNECTING SECTION
20 CIRCUIT UNIT
21, 21A, 21B FIRST RADIATING ELEMENT
22, 22A, 22B SECOND RADIATING ELEMENT
23, 23A, 23B HYBRID CIRCUIT
23S SHORT-CIRCUITED STUB
23T TRANSMISSION LINE
24, 25, 26, 28 GROUND CONDUCTOR
31, 31A, 31B INPUT TRACE
31a, 31b WIRING PORTION OF INPUT TRACE
32, 32A, 32B INPUT TRACE
32a, 32b WIRING PORTION OF INPUT TRACE
33, 33A, 33B FIRST TRACE
33V VIA CONDUCTOR
34, 34A, 34B SECOND TRACE
60 RADIO FREQUENCY INTEGRATED CIRCUIT (RFIC)
61 INTERMEDIATE FREQUENCY AMPLIFIER
62 UP/DOWN CONVERSION MIXER
63 TRANSMISSION-RECEPTION SWITCH
64 POWER DIVIDER
65 PHASE SHIFTER
66 ATTENUATOR
67 TRANSMISSION-RECEPTION SWITCH
68 POWER AMPLIFIER
69 LOW-NOISE AMPLIFIER
70 TRANSMISSION-RECEPTION SWITCH
75 SYSTEM-IN-PACKAGE MODULE (SiP MODULE)
76 CIRCUIT COMPONENT (ELECTRONIC COMPONENT)
80 BASEBAND INTEGRATED CIRCUIT
90 MODULE SUBSTRATE
CP CENTER PLANE
FP, FP1, FP2 FEED POINT
LI LINE OF INTERSECTION
P1, P2 INPUT PORT
P3, P4 OUTPUT PORT
PL1, PL2 PLANE
R RADIATING ELEMENT
T1, T1A, T1B, T2 INPUT-OUTPUT TERMINAL

1. An antenna module, comprising:
a first plate section and a second plate section that extend along two planes intersecting at an angle other than 1800;
a connecting section that connects the first plate section and the second plate section; and
at least one circuit, wherein
each of the at least one circuit includes:
a plurality of first radiating elements on the first plate section, each first radiating element having at least one feed point and radiates radio waves;
a plurality of second radiating elements on the second plate section, each second radiating element having at least one feed point and radiates radio waves;
a radio frequency integrated circuit mounted on a surface of the first plate section facing a side opposite to a side on which the plurality of first radiating elements are arranged, the radio frequency integrated circuit including a plurality of input-output terminals through which high-frequency signals are input and output;
a plurality of hybrid circuits on first plate section for respective feed points of the plurality of first radiating elements, each hybrid circuit including two input ports and two output ports;
two input traces for each of the plurality of hybrid circuits, the two input traces connecting respective two input ports to two of the plurality of input-output terminals of the radio frequency integrated circuit;
a first trace that connects a first output port of each of the plurality of hybrid circuits to a corresponding one of the plurality of first radiating elements; and
a second trace that connects a second output port of each of the plurality of hybrid circuits to a corresponding one of the plurality of second radiating elements, and
in each of the at least one circuit,
in plan view of the first plate section, with respect to a second direction perpendicular to a first direction, which is parallel to a line of intersection of the two planes, the plurality of hybrid circuits are individually arranged and at least partially overlap the radio frequency integrated circuit, and
among the plurality of hybrid circuits, a number of hybrid circuits arranged on a first side of a center plane is equal to or differs by one from a number of hybrid circuits arranged on a second side of the center plane, the center plane passing through a geometric center of the radio frequency integrated circuit and being perpendicular to the first direction.

2. The antenna module according to claim 1, wherein
the connecting section is arranged at at least two locations on respective sides of the center plane, spaced apart in the first direction, and
each of the second traces is routed via the connecting section on a same side of the center plane as the hybrid circuit to which a corresponding second trace is connected.

3. The antenna module according to claim 1, wherein a difference in line length of the two input traces is not greater than 2.8 times a line length of a transmission line connecting the two input ports of the hybrid circuit to which the two input traces are connected.

4. The antenna module according to claim 3, wherein
the plurality of second radiating elements are aligned in the first direction to constitute an array antenna, and
the difference in a sum of the line length of the second trace and an average of the line lengths of the two input traces between adjacent second radiating elements among the plurality of second radiating elements is not greater than a value obtained by dividing 12.8 times the line length of the transmission line connecting the two input ports of the hybrid circuit that is connected to the second trace by the number of the plurality of second radiating elements.

5. The antenna module according to claim 3, wherein
the plurality of first radiating elements are aligned in the first direction to constitute an array antenna, and
the difference in a sum of the line length of the first trace and an average of the line lengths of the two input traces between adjacent first radiating elements among the plurality of first radiating elements is not greater than a value obtained by dividing 12.8 times the line length of the transmission line connecting the two input ports of the hybrid circuit that is connected to the first trace by the number of the plurality of first radiating elements.

6. The antenna module according to claim 1, wherein the two output ports of each of the plurality of hybrid circuits are located farther from the center plane than the two input ports.

7. The antenna module according to claim 1, further comprising a system-in-package module in which the radio frequency integrated circuit and a plurality of electronic components are mounted, wherein
each of the two input traces connected to each of the plurality of hybrid circuits includes a wiring portion inside the system-in-package module and a wiring portion inside the first plate section, and
a magnitude relationship between a length of the wiring portion inside the system-in-package module and the length of the wiring portion inside the first plate section in each of the two input traces is reversed between the two input traces.

8. The antenna module according to claim 7, wherein
in the two input traces, a dielectric constant of a dielectric member supporting the wiring portions inside the system-in-package module is different from a dielectric constant of a dielectric member supporting the wiring portions inside the first plate section, and
a difference in line length between the wiring portions of the two input traces supported by the dielectric member whose dielectric constant is the higher is smaller than a difference in line length between the wiring portions of the two input traces supported by the dielectric member whose dielectric constant is the lower.

9. The antenna module according to claim 1, wherein
the feed point included in each of the plurality of first radiating elements and the plurality of second radiating elements includes two feed points,
radio waves radiated when power is fed to the two feed points have different polarization directions,
the polarization directions of radio waves radiated by the plurality of first radiating elements are parallel to each other when power is fed to one of the two feed points of each of the plurality of first radiating elements and are parallel to each other when power is fed to the other feed point of each of the plurality of first radiating elements, and
the polarization directions of radio waves radiated by the plurality of second radiating elements are parallel to each other when power is fed to one of the two feed points of each of the plurality of second radiating elements and are parallel to each other when power is fed to the other feed point of each of the plurality of second radiating elements.

10. The antenna module according to claim 9, wherein two hybrid circuits connected to the two feed points of one of the plurality of first radiating elements are arranged on a same side of the center plane.

11. The antenna module according to claim 1, wherein
the at least one circuit includes at least two circuits, and
an operating frequency band of the plurality of first radiating elements and the plurality of second radiating elements included in one of the at least one circuit is different from the operating frequency band of the plurality of first radiating elements and the plurality of second radiating elements included in another one of the at least one circuit.

12. The antenna module according to claim 11, wherein
the radio frequency integrated circuit is shared by two or more of at least two circuit,
in plan view of the first plate section, the plurality of first radiating elements of one of the at least one circuit individually overlap the plurality of first radiating elements of another one of the at least one circuit, and
in plan view of the second plate section, the plurality of second radiating elements of one of the at least one circuit individually overlaps the plurality of second radiating elements of another of the at least one circuit.

13. The antenna module according to claim 12, wherein the first radiating elements of the circuit operating in a relatively high-frequency band are arranged on a surface of the first plate section facing the side on which the plurality of first radiating elements are arranged, and the first radiating elements of the circuit operating in a relatively low-frequency band are arranged in an inner layer of the first plate section.

14. The antenna module according to claim 1, wherein the radio frequency integrated circuit overlaps the plurality of hybrid circuits in their entirety.

15. The antenna module according to claim 1, wherein a longest portion of each of the first and second plate sections are co-extensive along a direction of the line of intersection of the two planes.

16. The antenna module according to claim 1, wherein the input-output terminals of the radio frequency integrated circuit connected to the two input ports of each of the plurality of hybrid circuits are arranged at a same position in the first direction.

17. The antenna module according to claim 1, wherein a sum of the line length of the input trace and the second trace and a sum of the line length of the input trace and the first trace is equal between the hybrid circuits.

18. The antenna module according to claim 1, wherein transmission lines and short-circuited stubs are connected to the input ports and output ports of each of the plurality of hybrid circuits to widen a frequency band of the antenna module.
